(19) United States
(12) Patent Application Publication
(10) Pub. No.: US 2025/0363607 A1
(43) Pub. Date: Nov. 27, 2025

(54) COMPUTERIZED SYSTEMS AND METHODS FOR IDENTIFICATION OF DEFECTS IN SEGMENTED 3D IMAGES FOR ARTIFICIAL INTELLIGENCE TRAINING

(71) Applicant: Stratovan Corporation, Sacramento, CA (US)

(72) Inventors: David F. Wiley, Sacramento, CA (US); Christian Woodhouse, Sacramento, CA (US); Zoe Krueger, Sacramento, CA (US); Sidney Inouye, Sacramento, CA (US)

(21) Appl. No.: 18/908,502

(22) Filed: Oct. 7, 2024

Related U.S. Application Data
(60) Provisional application No. 63/542,994, filed on Oct. 6, 2023.

(51) Int. Cl. G06T 7/00; G06F 3/04842; G06T 5/60

(52) U.S. Cl. CPC G06T 7/0002; G06F 3/04842; G06T 5/60; G06T 2200/04; G06T 2200/24; G06T 2207/30168

(57) ABSTRACT

In some embodiments, the system is configured to import segmented three dimensional images and associated labels, perform batch processing operations such as cropping, scaling, and alignment, and apply voxel attributes including volume, mass, and density to generate statistical representations that automatically identify outlier images and potential segmentation errors. In some embodiments, defect analysis employs artificial intelligence models to classify, correct, or remove anomalies through axis evaluation, mirror operations, and artifact removal. In some embodiments, images are annotated with extracted attributes and grouped into categories to optimize training data sets for downstream machine learning tasks, and reviewed images and metadata are exported for analysis and integration. In some embodiments, the system tracks operator performance and workflow metrics across segmentation and review processes to facilitate quality control and training. In some embodiments, the system supports collaborative review with graphical overlays for manual validation and feedback loops to continuously improve segmentation accuracy and efficiency.

### CROSS-REFERENCE TO RELATED APPLICATION

This application claims the priority and benefit of U.S. Provisional Patent Application No. 63/542,994, filed Oct. 6, 2023, which is incorporated by reference herein in its entirety.

### FIELD OF THE DISCLOSURE

The present disclosure is generally related to 3D segmentations, labeling, annotations and more particularly, to a decision intelligence (DI)-based computerized framework for identifying anomalies in segmented 3D images.

### BACKGROUND

Segmenting 3D images is a way to distinguish various parts of a living organism for medical image analysis; or objects from 3D scans in industrial applications such as machine parts or guns, knives, explosives in baggage scans in airport security industry. It involves identifying and delineating specific regions or structures of interest within a 3D image. This process is used for various purposes in healthcare, including diagnosis, treatment planning, and research; and used further in airport security, for example, for detection of dangerous items such as guns, knives, and explosives.

In some embodiments described herein, normal images are segmented by an operator without issue. However, human error and non-human error can result in abnormal images (e.g., corrupt images, artifacts, etc.) or anomalous images (e.g., diseased liver, abnormal mass, volume, shape) requiring image review and correction. When dealing with many thousands of images, this task becomes cumbersome to manually handle. Therefore, there is a need for systems and methods to identify and/or categorize images-based object characteristics thus identifying potential errors and a means for correcting them.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 illustrates a system import program step according to some embodiments.

FIG. 2 shows the system generating a first graphical user interface which includes a patient/specimen tab for loading specimen data files according to some embodiments.

FIG. 3 shows an example segmented dataset according to some embodiments.

FIG. 4 illustrates the execution of a volume rendering module according to some embodiments.

FIG. 5 shows the execution of a segment module according to some embodiments.

FIG. 6 shows a resulting GUI generated by the segment module after the batch operations import function is selected according to some embodiments.

FIG. 7 depicts a populated import image and label section according to some embodiments.

FIG. 8 illustrates the segment data import as a first step in a manual review process according to some embodiments.

FIG. 9 shows a step of returning to the patient/specimen tab for review according to some embodiments.

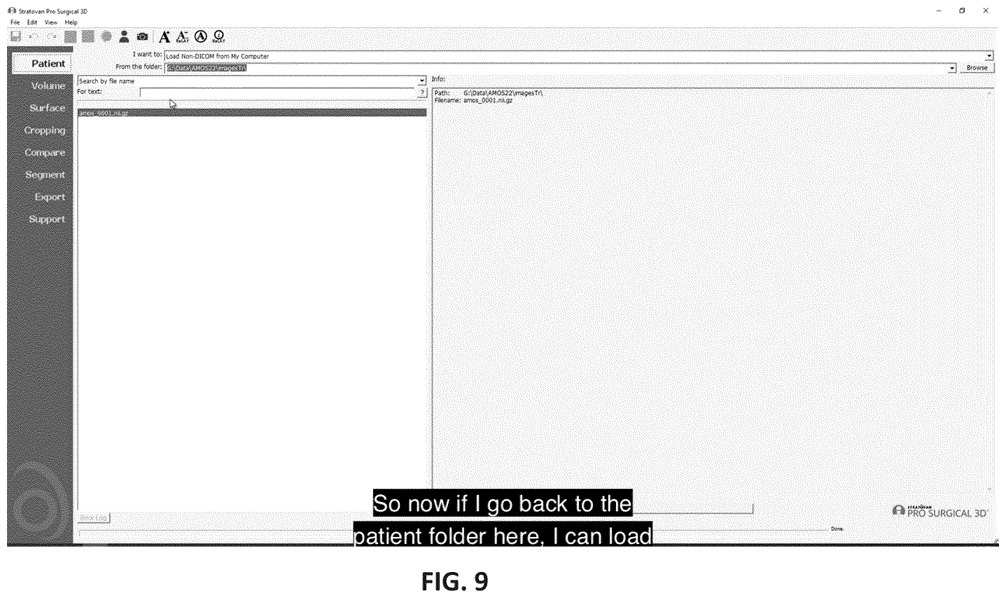

FIG. 10 shows a non-limiting example of reviewing the imported segmented image according to some embodiments.

FIG. 11 shows a re-import of the segment data with the x-axis flipped according to some embodiments.

FIG. 12 shows the volume image and the segmentation properly aligned according to some embodiments.

FIG. 13 illustrates another view showing successful completion of a validation method according to some embodiments.

FIG. 14 shows executing a batch operation import for all scans after a manual orientation validation step according to some embodiments.

FIG. 15 illustrates generating a new segmented data file for all specimen according to some embodiments.

FIG. 16 shows a computer implemented steps for optimizing data integrity according to some embodiments.

FIG. 17 illustrates a step of selecting arbitrary images for defect review according to some embodiments.

FIG. 18 illustrates the problem of having to manually review each image and/or manually execute instructions in one or more modules according to some embodiments.

FIG. 19 depicts aspects of the system that enable automated segment data defect evaluation according to some embodiments.

FIG. 20 shows selection of a segmentation edit function executed by the segment module according to some embodiments.

FIG. 21 depicts the segment module generating an attribute section according to some embodiments.

FIG. 22 illustrates the segment module generating an label attribute database editing window according to some embodiments.

FIG. 23 illustrates modifying various label attribute fields according to some embodiments.

FIG. 24 illustrates how to format different label attribute categories according to some embodiments.

FIG. 25 shows the system generating a file comprising the label attribute assignments according to some embodiments.

FIG. 26 shows contents of a non-limiting example attribute file according to some embodiments.

FIG. 27 depicts the system accessing the label attribute file to populate one or more portions of the attribute section according to some embodiments.

FIG. 28 depicts a step of selecting and/or updating an object's attribute according to some embodiments.

FIG. 29 shows assigning the attribute to the voxel object data according to some embodiments.

FIG. 30 illustrates the system displaying the replacement and/or addition of the object label attribute number with the attribute name according to some embodiments.

FIG. 31 illustrates the segment module executing an attribute and a sub-attribute operation to voxel data according to some embodiments.

FIG. 32 shows the resulting re-labeling transformation of the original voxel data to a new attribute and a new sub-attribute.

FIG. 33 depicts a step of executing defect analysis according to some embodiments.

FIG. 34 shows a list of the object label attribute assignments according to some embodiments.

FIG. 35 illustrates the execution of a defect analysis function, which may be referred to as “quality assurance” herein according to some embodiments.

FIG. 36 shows the generation of a defect analysis GUI according to some embodiments.

FIG. 37 shows an outlier image according to some embodiments.

FIG. 38 depicts what an expected scan should look like according to some embodiments.

FIG. 39 shows removing the outlier according to some embodiments.

FIG. 40 illustrates the system executing a display of a change in the statistical representation according to some embodiments.

FIG. 41 shows an axis evaluation according to some embodiments.

FIG. 42 illustrates a model fit through reflection according to some embodiments.

FIG. 43 illustrates implements one or more steps that include mirror and/or image type analysis according to some embodiments.

FIG. 44 depicts the system generating data and/or metadata for one or more image files according to some embodiments.

FIG. 45 shows a non-limiting example data indexing output according to some embodiments.

FIG. 46 shows one or more steps for executing image type evaluation according to some embodiments.

FIG. 47 illustrates evaluating CT scan outliers according to some embodiments.

FIG. 48 depicts an unusual outlier according to some embodiments.

FIG. 49 shows the defect of interest in the unusual bladder mass according to some embodiments.

FIG. 50 depicts specifying attributes for outlier analysis grouping according to some embodiments.

FIG. 51 shows adding an organ as an attribute for evaluation and sorting according to some embodiments.

FIG. 52 shows executing defect analysis on an attribute group according to some embodiments.

FIG. 53 shows a display of a grouped outlier according to some embodiments.

FIG. 54 shows classification and attribute assignment for the image according to some embodiments.

FIG. 55 shows an MRI scan type analysis according to some embodiments.

FIG. 56 shows an unusual image segmentation with an artifact according to some embodiments.

FIG. 57 depicts the execution of a manual defect tool removing the artifact according to some embodiments.

FIG. 58 shows the fixed image returned to the data set according to some embodiments.

FIG. 59 depicts steps for executing a medical evaluation according to some embodiments.

FIG. 60 shows selection of an outlier in a combined statistical representation category according to some embodiments.

FIG. 61 shows a review of the outlier revealing a left kidney that is much larger than the right.

FIG. 62 illustrates generating a volume rendering without segmentation according to some embodiments.

FIG. 63 depicts adding attributes to the image to use as training data for the medical evaluation AI model according to some embodiments.

FIG. 64 shows a step of analyzing exported data according to some embodiments.

FIG. 65 shows a labeled unusual outlier according to some embodiments.

FIG. 66 shows an exporting function of the segment module according to some embodiments.

FIG. 67 shows the population of the export section with CT images according to some embodiments.

FIG. 68 shows exporting of images and labels according to some embodiments.

FIG. 69 shows steps for using an output file for further analysis according to some embodiments.

FIG. 70 shows the system generating and/or outputting metadata associated with the reviewed images according to some embodiments.

FIG. 71 displays an indexing scan output data according to some embodiments.

FIG. 72 shows an instance output dataset according to some embodiments.

FIG. 73 illustrates a computer system enabling or comprising the systems and methods in accordance with some embodiments.

### DETAILED DESCRIPTION

In some embodiments, the system includes one or more computers comprising one or more processors and one or more non-transitory computer readable media. In some embodiments, the one or more non-transitory computer readable media comprises instructions that when executed by the one or more processors to execute and/or enable one or more program and/or method steps. In some embodiments, a step includes to execute a segmentation platform, which is hereafter referred to as the “system.”

The graphical user interfaces (GUIs) described herein do not limit the system to a particular configuration but are instead intended to illustrate the functionality of system according to some embodiments. Any feature displayed in the drawings is understood to be part of the disclosure, where a description of contents and/or functionality in the drawings can be used to describe executed program steps when defining the metes and bounds of the system whether a corresponding written description is present or not.

In some embodiments, the system includes a 3D DICOM viewer. In some embodiments, the system is configured to enable a user to load DICOM data directly from PACS, CD/DVD, USB, and/or local computer. In some embodiments, the system is configured to enable a user to upload DICOM data to PACS directly from referral patient CD/DVD and local computer. In some embodiments, the system is configured to enable a user to implement a patient search to locate patient data on a PACS. In some embodiments, the system is configured to enable a user to load common non-DICOM file formats: NifTi (.nii), Visualization Toolkit (.vtk), and ANALYZE (.hdr). In some embodiments, the system is configured for one or more of CT and MR DICOM modalities. In some embodiments, the system is configured to perform 3D isosurface reconstruction and volume rendering. In some embodiments, the system is configured to execute multi-planar slicing. In some embodiments, the system is configured to execute oblique slicing. In some embodiments, the system is configured to enable instant and interactive surface extraction and export to STL and PLY formats. In some embodiments, the system is configured to enable a user to easily anonymize and de-identify patient scans. In some embodiments, the system includes window/level (brightness and contrast) presets. In some embodiments, the system is configured to execute screen capture. In some embodiments, the system is configured to enable axis-aligning and/or cropping with context. In some embodiments, the system is configured to generate side-by-side comparative assessment, for example, for pre-operative and post-operative scans. In some embodiments, the system includes an integrated customer support portal.

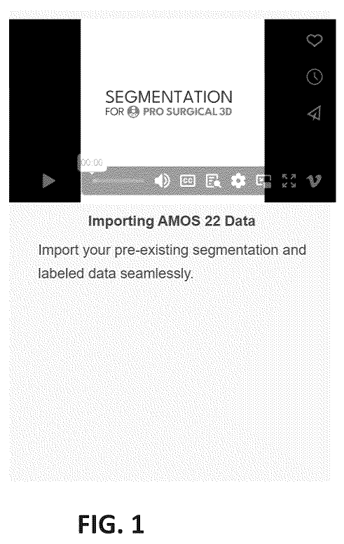

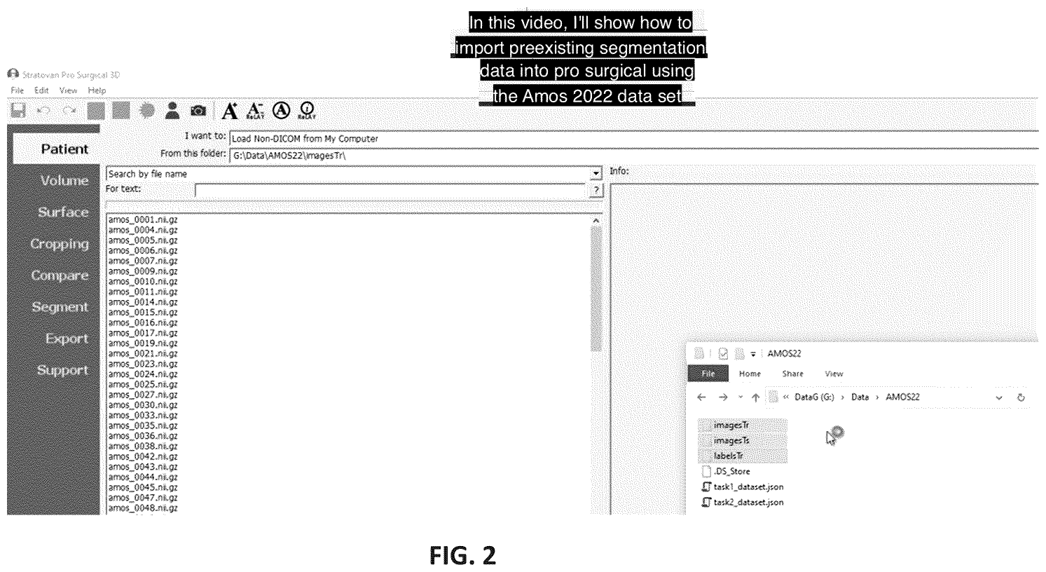

FIG. 1 illustrates a system import program step according to some embodiments. Some embodiments include a step to import pre-existing segmentation images and/or data labels into the segmentation program. FIG. 2 shows the system generating a first graphical user interface which includes a patient/specimen loading tab according to some embodiments. In some embodiments, the system is configured to display links for one or more of a patient module, a volume module, a surface module, a cropping module, a compare module, a segment module, and export module, and/or a support module. In some embodiments, one or more module links may be represented by one or more tabs on the GUI.

In some embodiments, the patient/specimen module is configured to enable the importation of segmentation data. In some embodiments, segmentation data includes one or more images and/or one or more image labels. In some embodiments, the patient module is configured to display an action selection menu, a folder selection menu, a search menu, a file content section, and/or an information section.

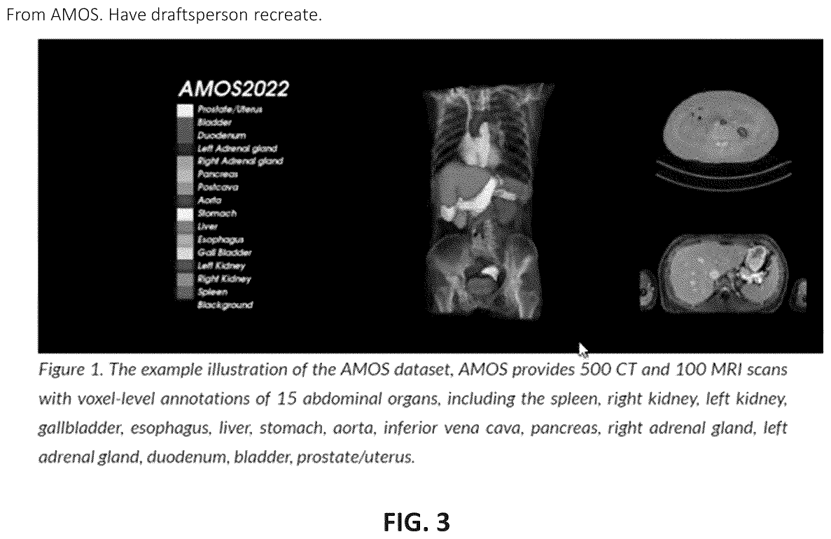

FIG. 3 shows an example segmented dataset according to some embodiments. In some embodiments, the segmented dataset includes one or more annotations that include a label for one or more voxels. In some embodiments, a voxel represents a tiny three-dimensional volume element or rectilinear region within the 3D space (a voxel is a 3D extension of a 2D pixel). In some embodiments, it has width, height, and depth, making it a 3D unit. In some embodiments, the size of a voxel determines the spatial resolution of the 3D image. In some embodiments, smaller voxels provide higher spatial resolution, allowing for more detailed representation of the imaged object, but they also result in larger data volumes. In some embodiments, each voxel contains a value or intensity that represents a property of the underlying object at that specific location in 3D space.

In medical imaging, for example, in a system described herein according to some embodiments, voxel values can represent tissue density (Hounsfield units in CT), tissue type (gray matter, white matter in MRI), or other properties relevant to the imaging modality. In some embodiments, voxel data is organized in a three-dimensional rectilinear grid, with each voxel located at a specific position defined by its x, y, and z coordinates. In some embodiments, the entire grid collectively forms the 3D image. In some embodiments, the system is configured to render voxels as small, discrete, cubes or as points in 3D space. In some embodiments, the system is configured to assign colors or opacity to voxels based on their intensity values, complex 3D structures can be visualized and analyzed. In some embodiments, the system is configured to use the voxel data to execute instructions for various image processing tasks for the imported 3D images, such as segmentation (identifying and delineating structures of interest), registration (aligning multiple 3D images), and volume rendering (creating 3D visualizations). In some embodiments, the system is configured to use the voxel data to execute instructions for image defect identification as further described herein.

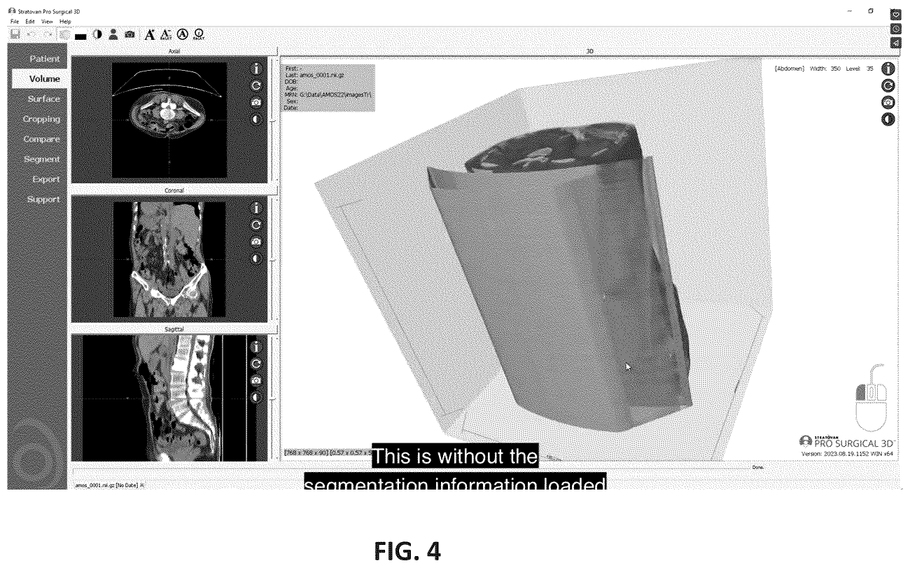

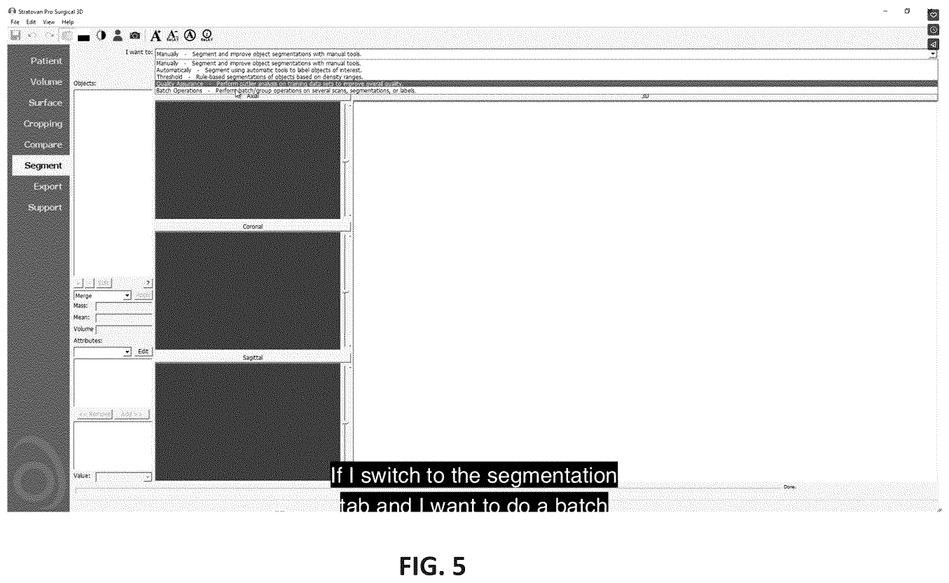

FIG. 4 illustrates the execution of a volume rendering module according to some embodiments. In some embodiments, the system is configured to generate one or more images that do not include segmentation information. FIG. 5 shows the execution of a segment module according to some embodiments. In some embodiments, the segment module is configured to generate a selection menu. In some embodiments, the selection menu includes a defect analysis, which is labeled as quality assurance in this non-limiting embodiment. Other functionality of the segment module is described in the selection menu shown in FIG. 5 according to some embodiments. In some embodiments, the segment module is configured to enable import (e.g., a batch import) of segment data.

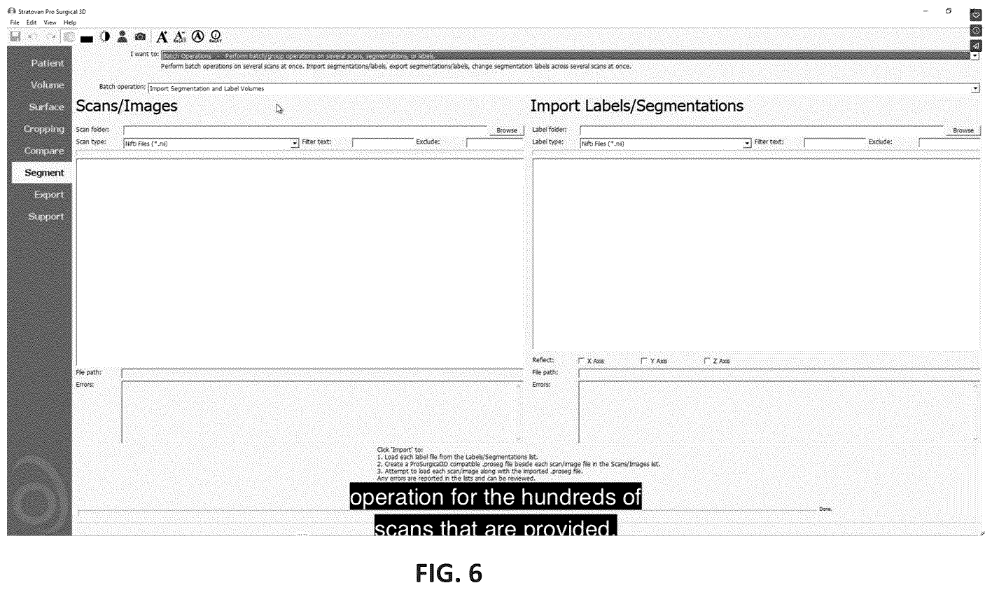

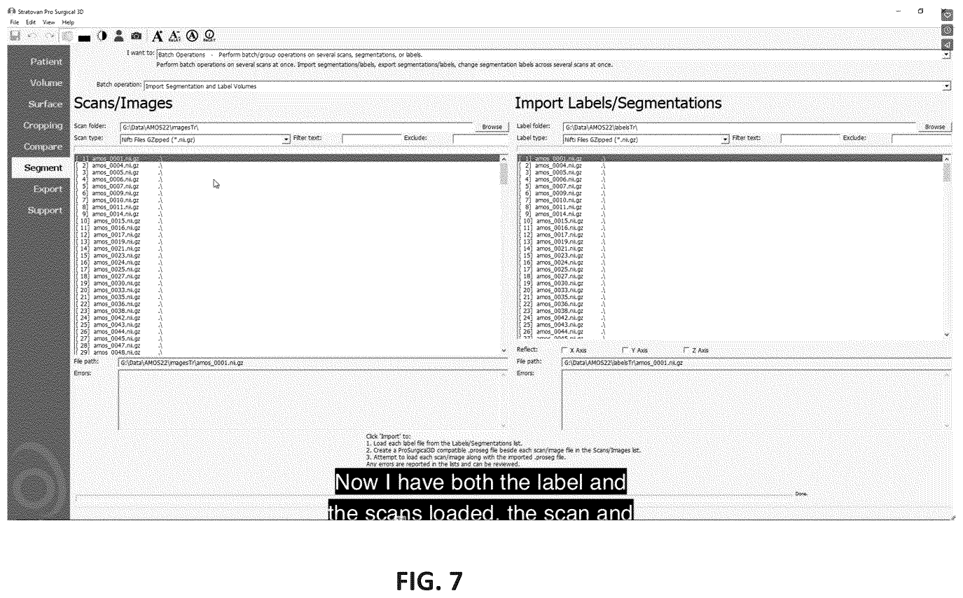

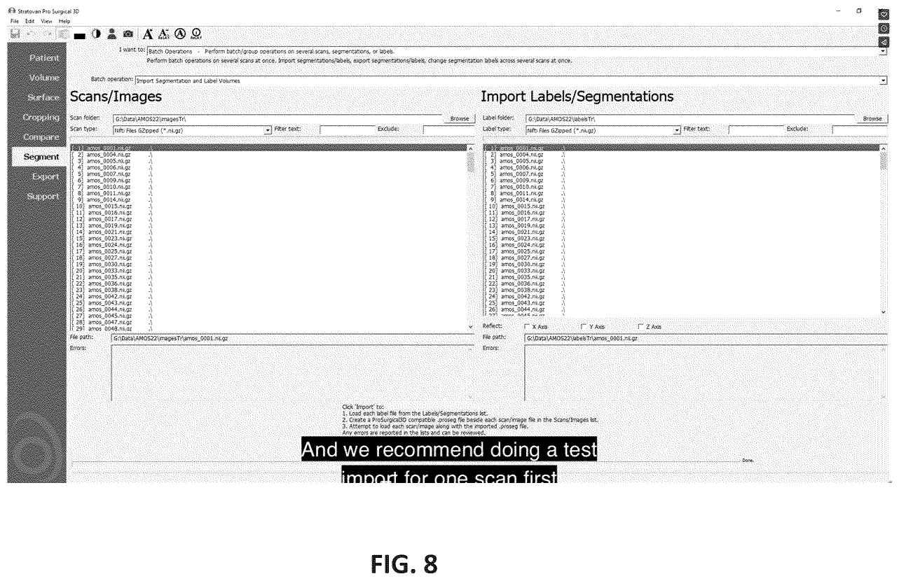

FIG. 6 shows a resulting GUI generated by the segment module after the batch operations function is selected according to some embodiments. In some embodiments, the batch operations GUI includes an image section and a label section, as well as one or more icons enabling the importation of each segment data type. FIG. 7 depicts a populated image and label section according to some embodiments. FIG. 8 illustrates the segmentation data import as a first step in a manual review process according to some embodiments.

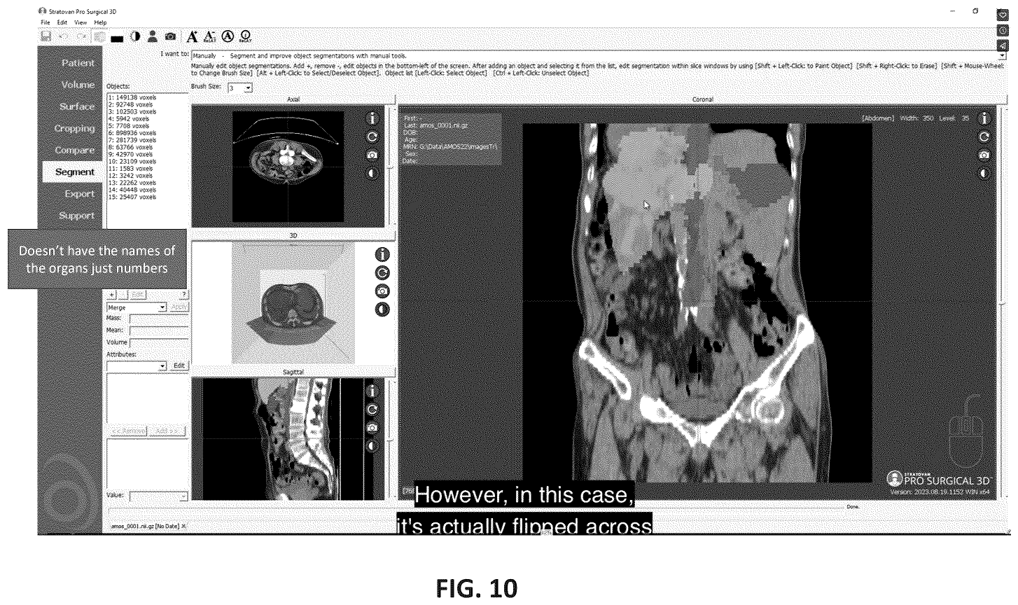

In some embodiments, after the segmentation data is loaded, the patient module is configured to link to and/or enable selection of one or more images in the segmentation data. FIG. 10 shows a non-limiting example imported segmented image according to some embodiments. As shown in FIG. 10, the segmentation data labels do not have a specific name associated with each voxel label as displayed in the objects window according to some embodiments. In addition, the image shown according to some embodiments has segments that do not match the orientation of the volume image.

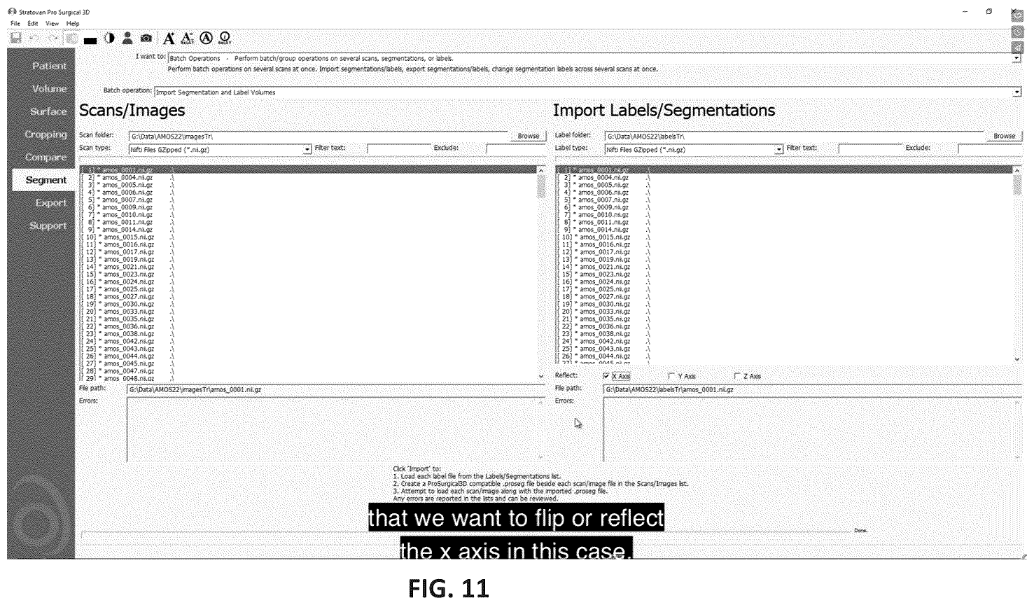

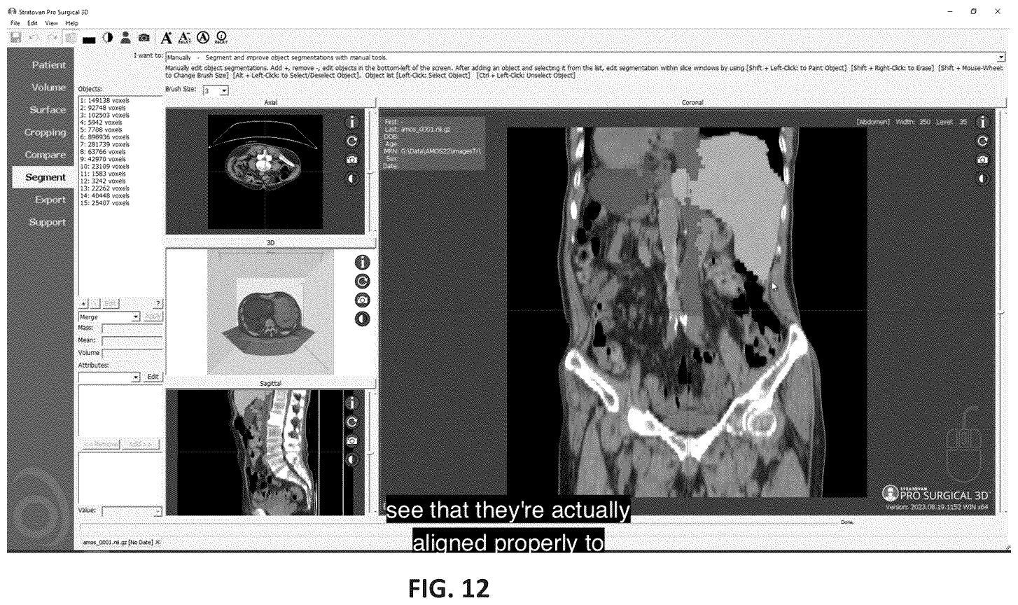

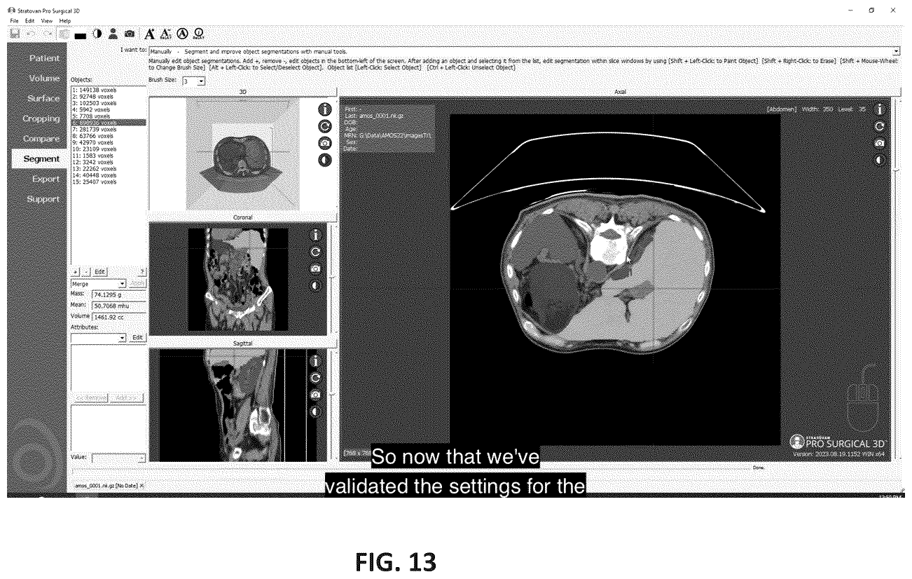

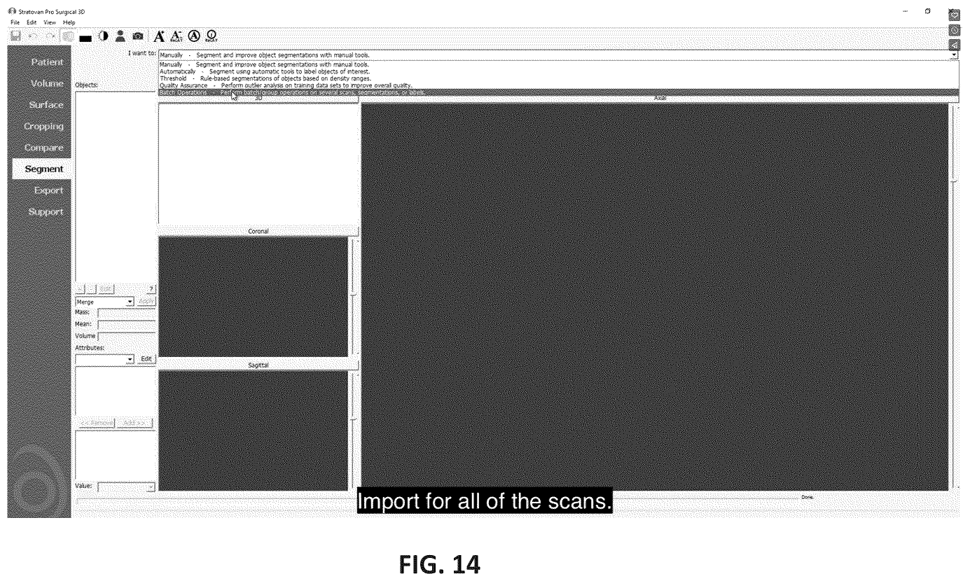

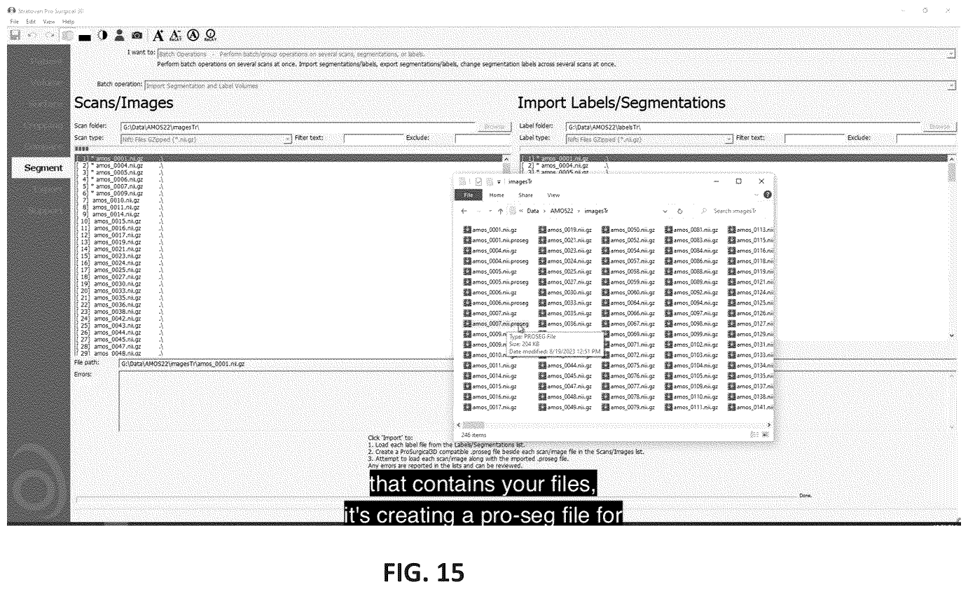

In some embodiments, the system is configured to enable a user to manually improve segmentations. FIG. 11 shows a re-import of the segment data with the x-axis flipped according to some embodiments. FIG. 12 shows the volume image and the segmentation properly aligned according to some embodiments. FIG. 13 illustrates another view showing successful completion of a validation method according to some embodiments. FIG. 14 shows executing a batch operation import for all scans after a manual orientation validation step according to some embodiments. In some embodiments, the system is configured to generate one or more new files that comprises a combination of the volume images and the segment labels according to some embodiments. In some embodiments, new file only contains the segmentation label information and/or is linked to the original file. FIG. 15 illustrates generating a new segmentation file according to some embodiments.

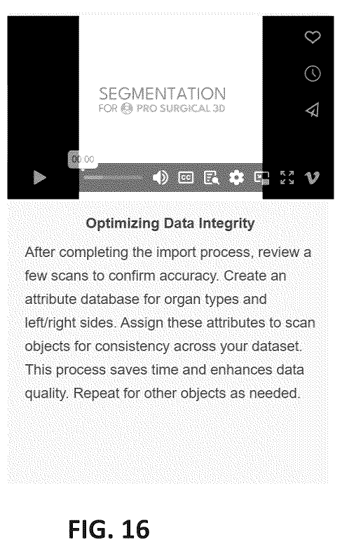

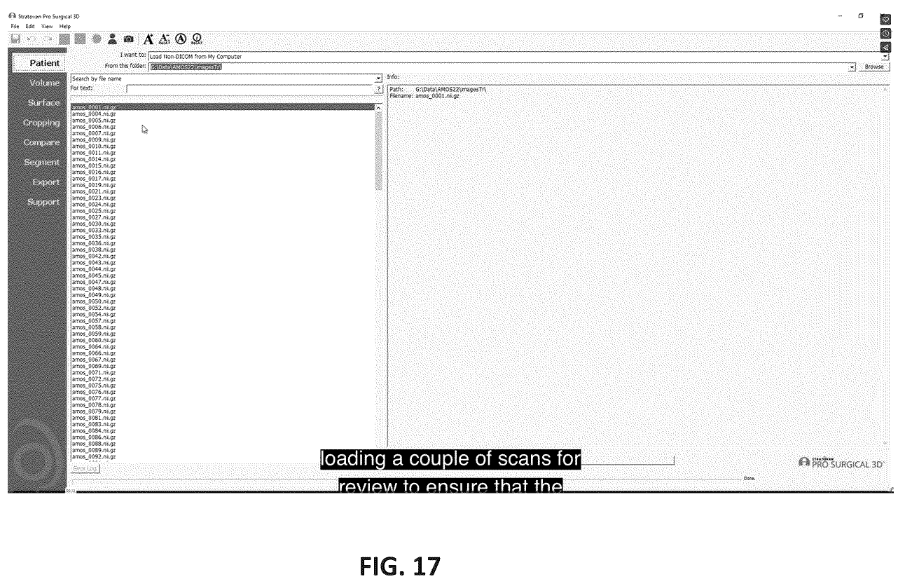

FIG. 16 shows computer implemented steps for optimizing data integrity according to some embodiments. FIG. 17 illustrates a step of selecting random images for defects according to some embodiments. However, while enabled by the system, this manual method of review does not automatically identify and/or categorize images with specific defects, which becomes problematic when attempting to use unreviewed images for an artificial intelligence (AI) training set.

For an AI algorithm (e.g., machine learning) to learn to recognize images, it must be provided with properly labeled training data train the AI according to some embodiments. In the Al model (which includes any subset such as machine learning, any reference to a particular subset is also a reference to an AI model) described herein according to some non-limiting embodiments, two main types training data and testing data are used to train the AI model. In some embodiments, training includes having a set of images to teach the algorithm a specific task, and another set of images to test how well it has learned that task. In some embodiments, this process helps ensure that the system algorithm can generalize its learning and perform well on new, unseen data, which is the goal of most machine learning applications.

In some embodiments, training data includes a larger dataset that the algorithm uses to learn patterns and relationships. It serves as the foundation for the algorithm's understanding of the task or problem. In some embodiments, the training images are used to teach the algorithm how to recognize or classify objects or patterns in those images. In some embodiments, testing data include is a separate dataset that the algorithm has not seen during training. In some embodiments, testing data is used to evaluate the AI model's performance. In some embodiments, the testing images are used to assess how well the algorithm can generalize its learning to new, unseen data. In some embodiments, the system is configured to enable a user to assign a designation of an image as a training data and/or test data.

In some embodiments, during the training process, the system executes an AI algorithm to cause the one or more processors to executes steps that analyzes the training images, extract features, and learn the underlying patterns or relationships in the data. For image classification tasks executed by the system, this might involve recognizing shapes, colors, textures, or other features in the images according to some embodiments.

After the training is complete, the algorithm's performance is assessed using the testing images. In some embodiments, this helps determine how well the algorithm can make accurate predictions or classifications on new, previously unseen data. In some embodiments, the evaluation metrics can include accuracy, precision, recall, F1-score, overlap, bleed, Intersection over Union (IoU), or others, depending on the specific task. In some embodiments, the system is configured to enable a user to adjust the AI algorithm's parameters, architecture, and/or the amount of training data to improve its performance based on the evaluation results.

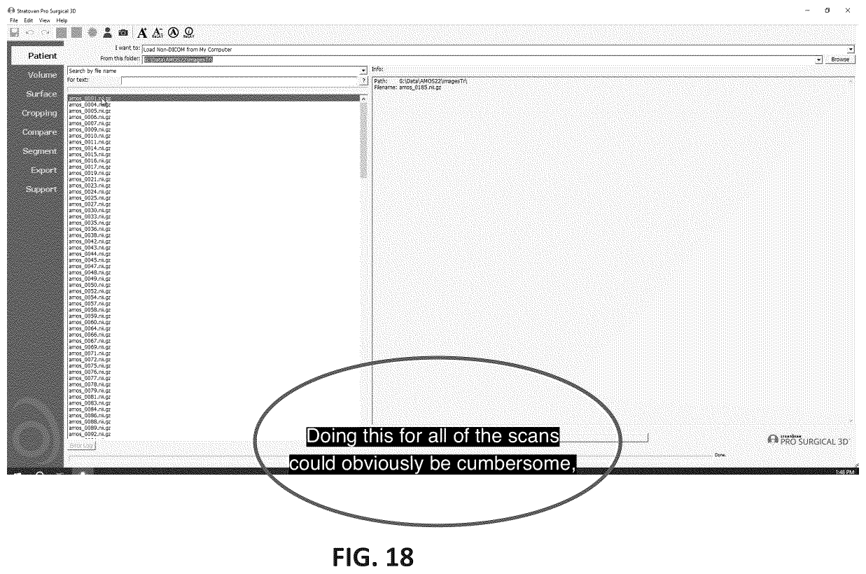

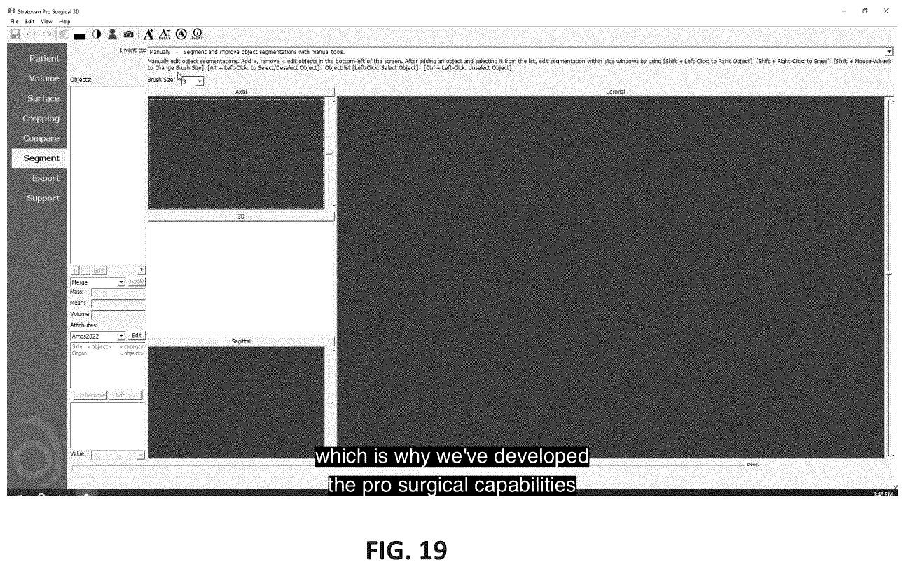

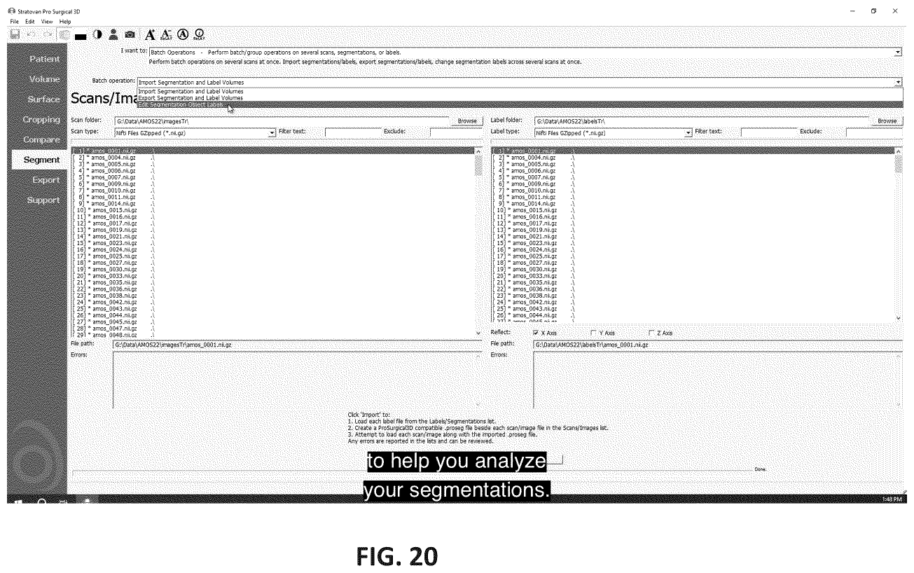

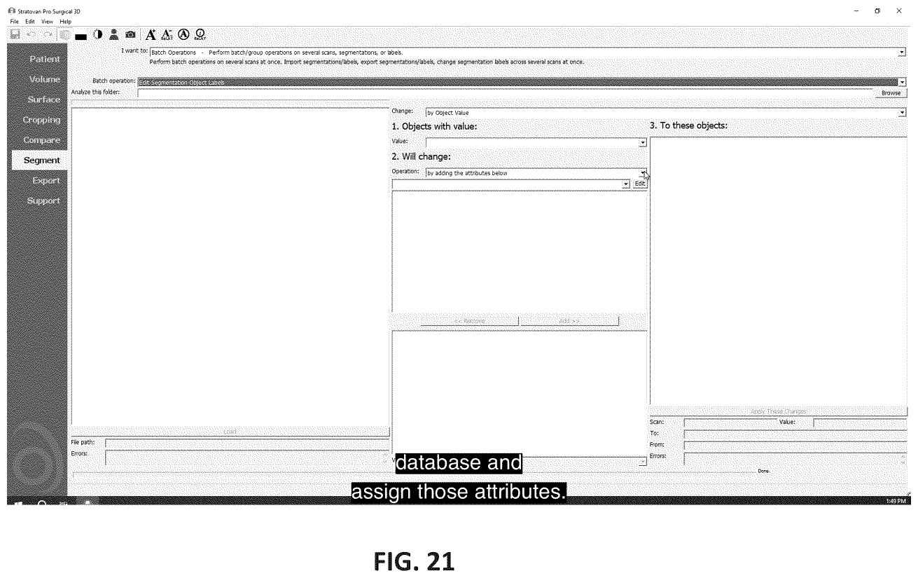

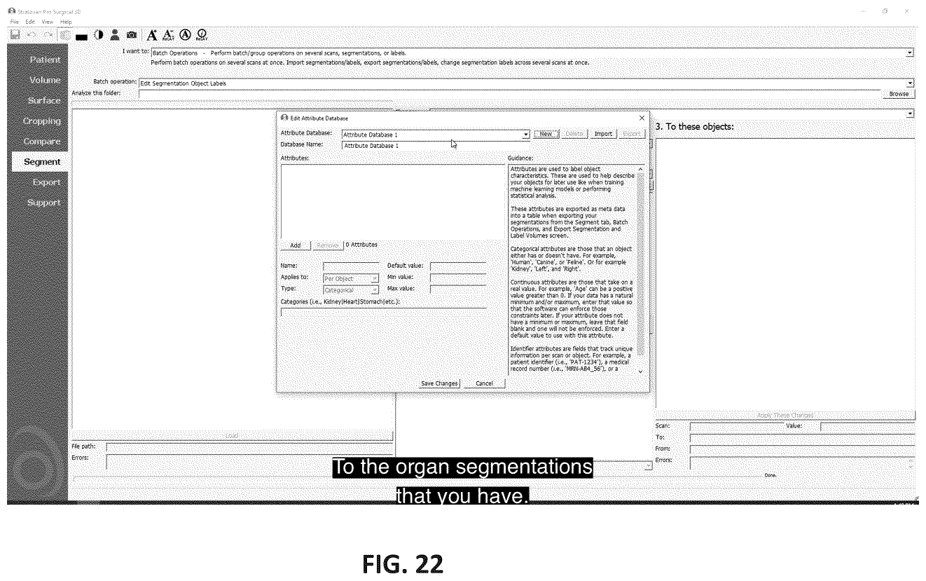

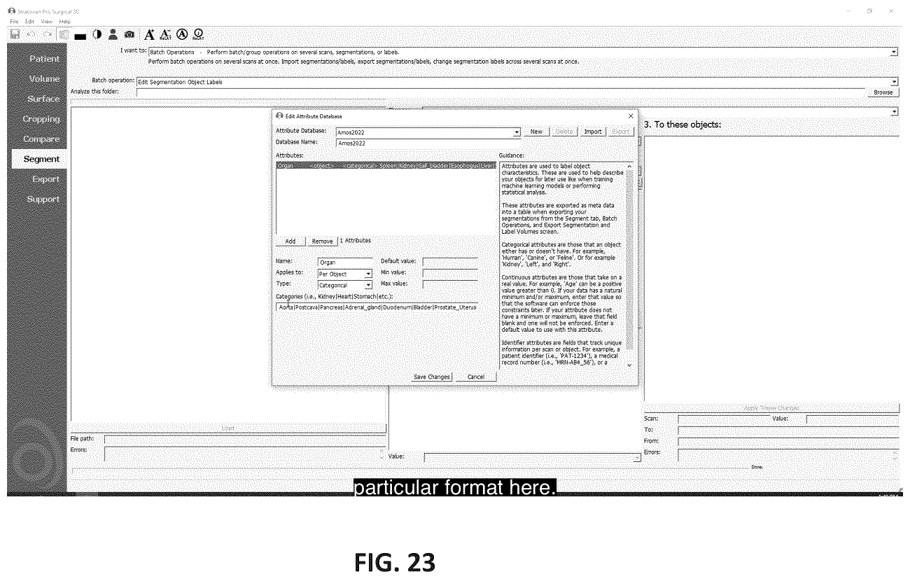

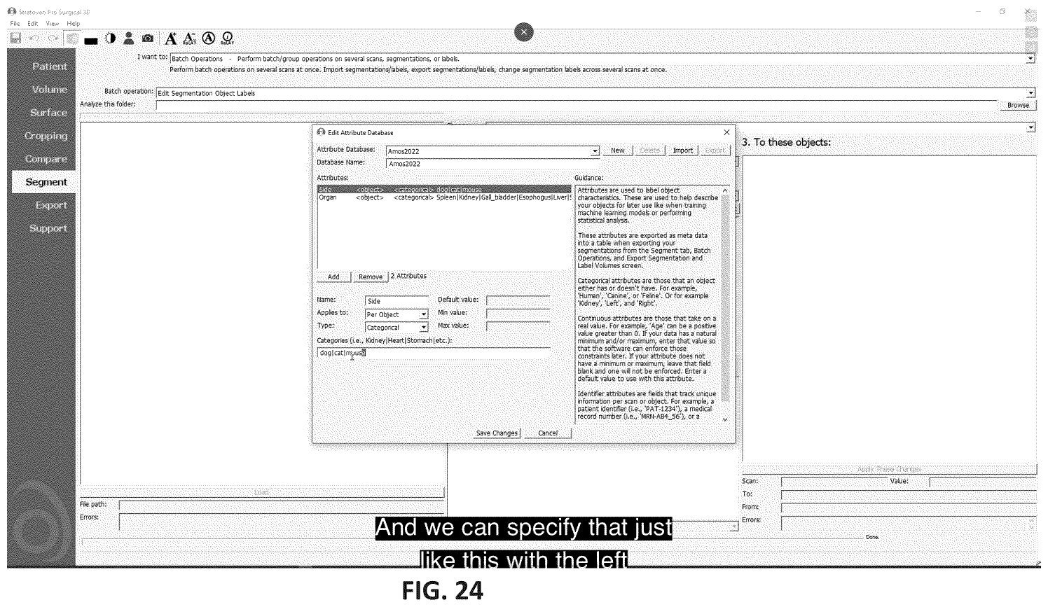

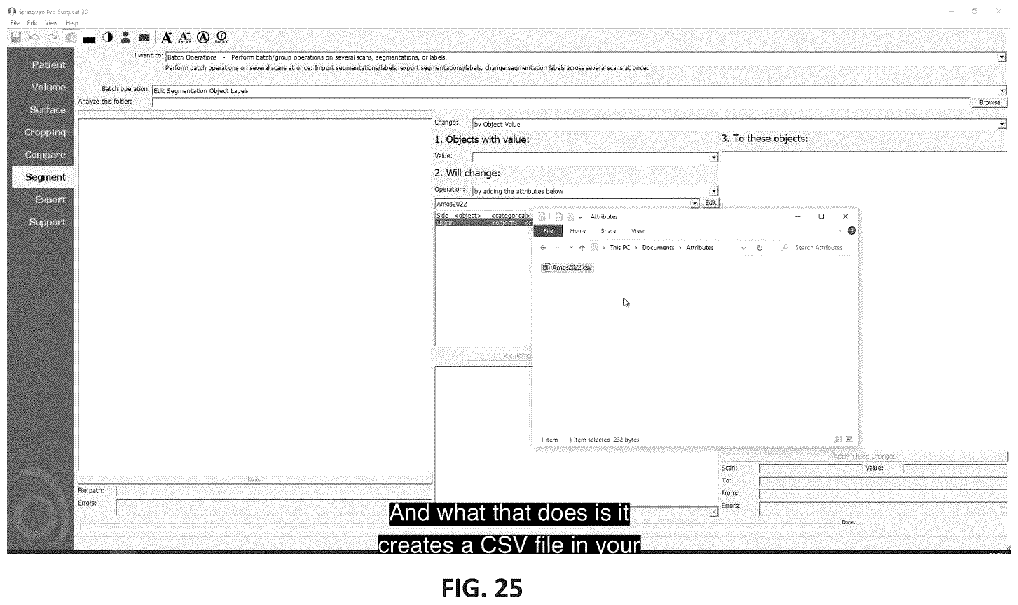

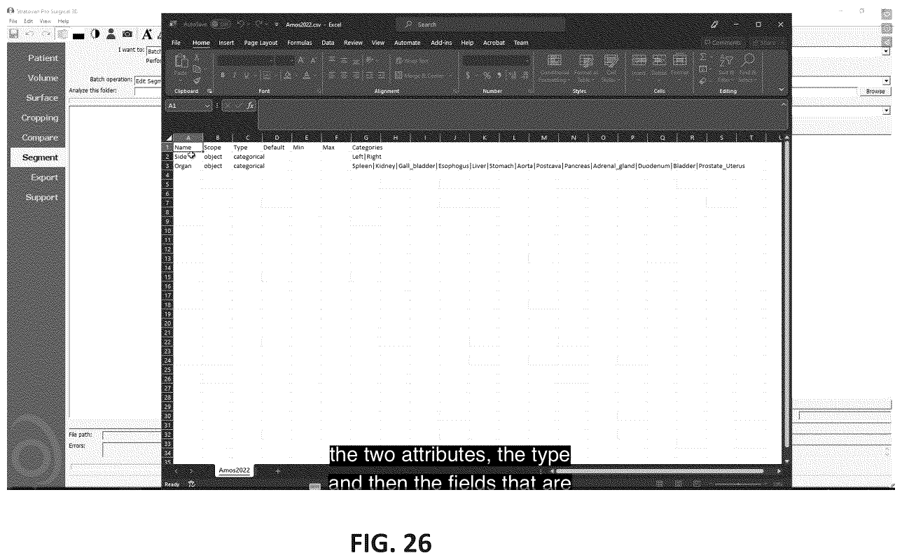

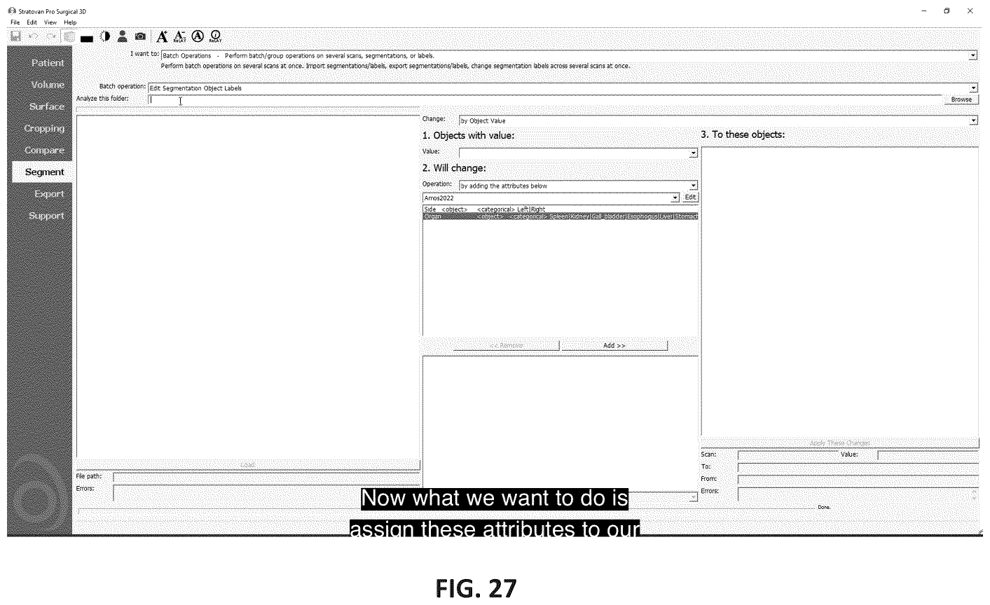

FIG. 18 illustrates the problem of having to manually review each image and/or manually execute instructions in one or more modules according to some embodiments. FIG. 19 depicts aspects of the system that enable automated segment data defect evaluation according to some embodiments. FIG. 20 shows selection of a segmentation edit function executed by the segment module according to some embodiments. FIG. 21 depicts the segment module generating an attribute section according to some embodiments. FIG. 22 illustrates the segment module generating an attribute database editing window according to some embodiments. FIG. 23 illustrates modifying various fields according to some embodiments. FIG. 24 illustrates how to format different categories according to some embodiments. FIG. 25 shows the system generating a file comprising the attribute assignments according to some embodiments. FIG. 26 shows contents of a non-limiting example attribute file according to some embodiments. FIG. 27 depicts the system accessing the attribute file to populate one or more portions of the attribute section according to some embodiments.

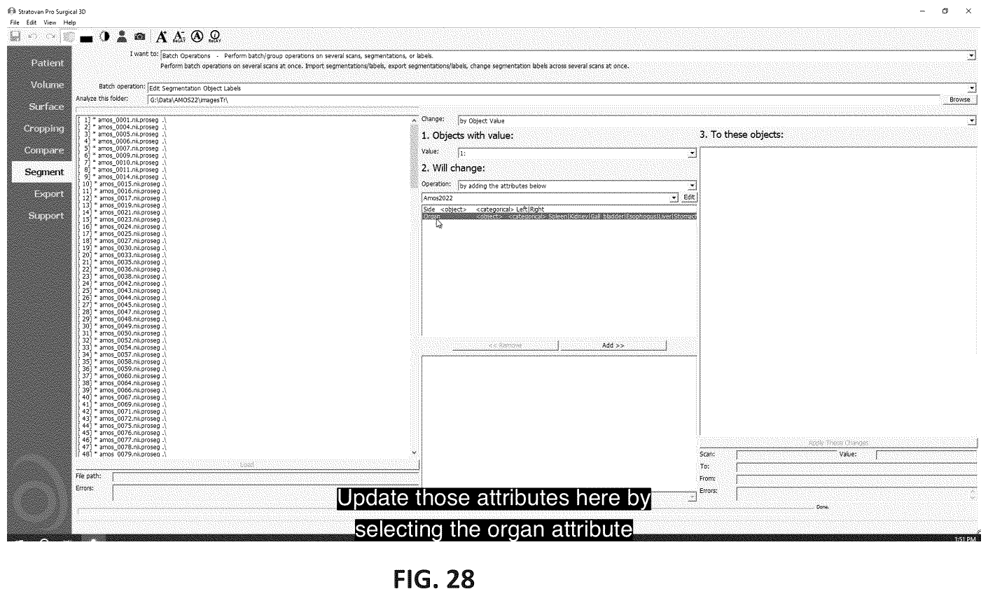

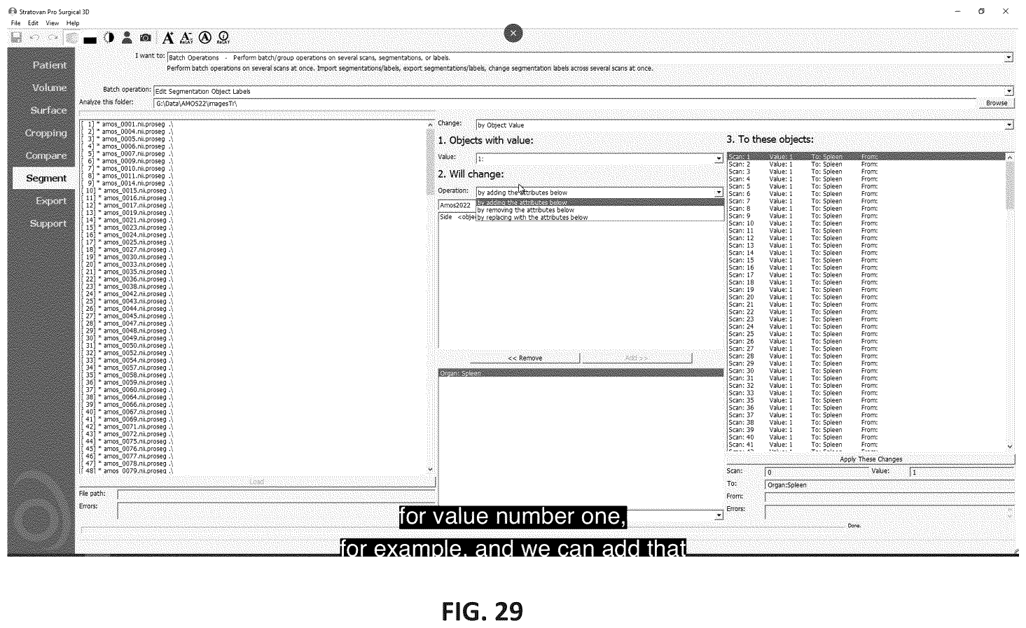

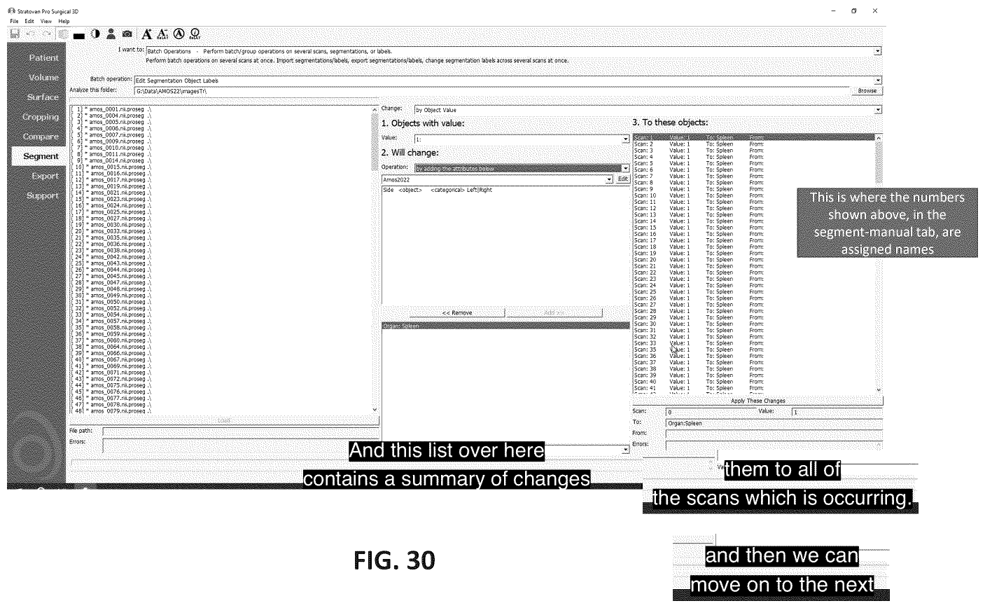

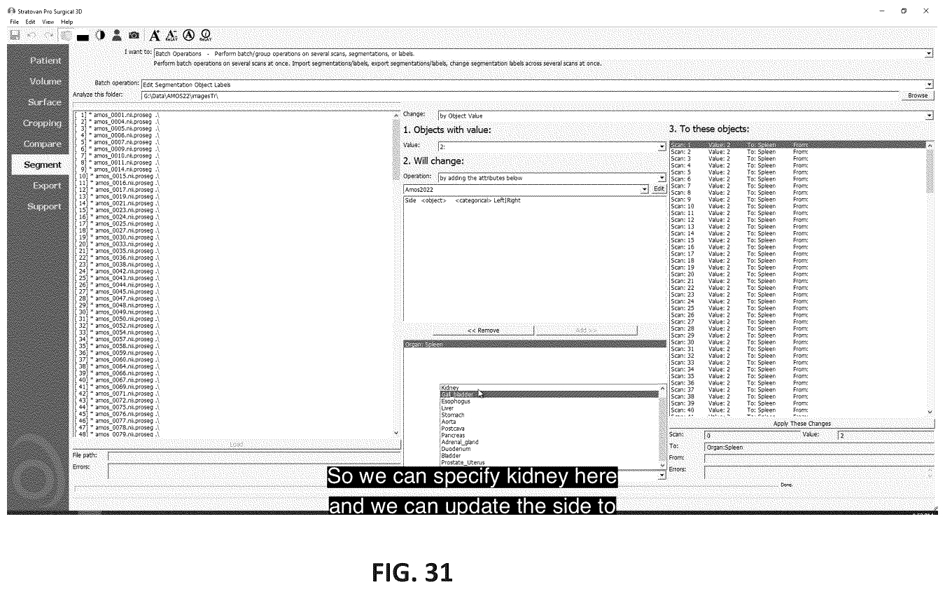

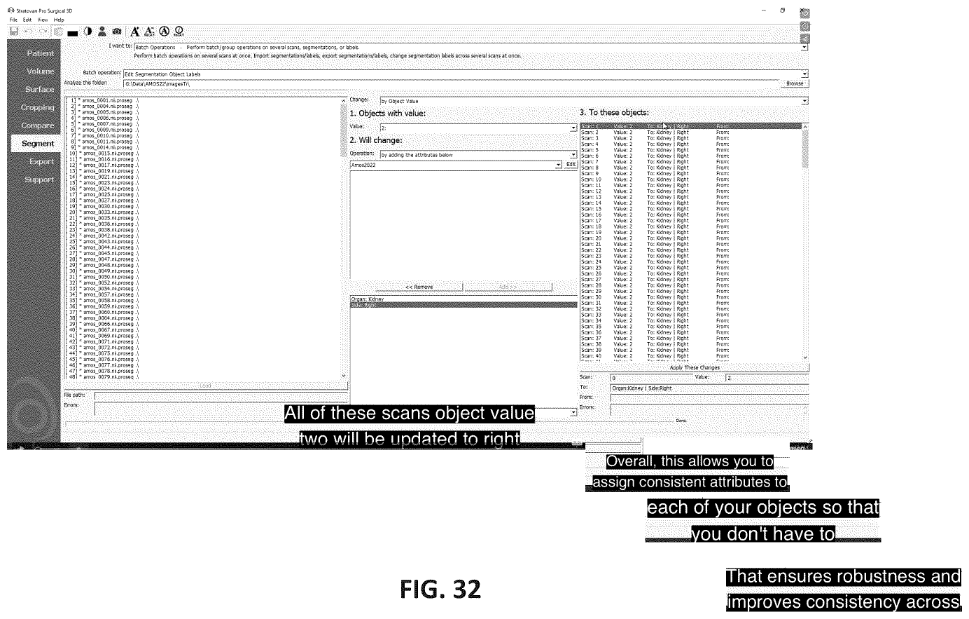

FIG. 28 depicts a step of selecting and/or updating an attribute according to some embodiments. FIG. 29 shows assigning the attribute to the voxel data according to some embodiments. FIG. 30 illustrates the system displaying the replacement and/or addition of the attribute number with the attribute name according to some embodiments. FIG. 31 illustrates the segment module executing an attribute and a sub-attribute operation to voxel data according to some embodiments. FIG. 32 shows the resulting transformation of the original voxel data to a new attribute and a new sub-attribute. In some embodiments, by executing instructions to generate attributes and sub-attributes, the system provides a way to sort and/or group by one or more of each, which improves the defect analysis further described herein.

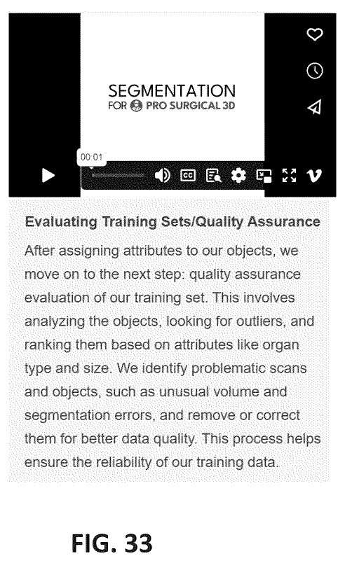

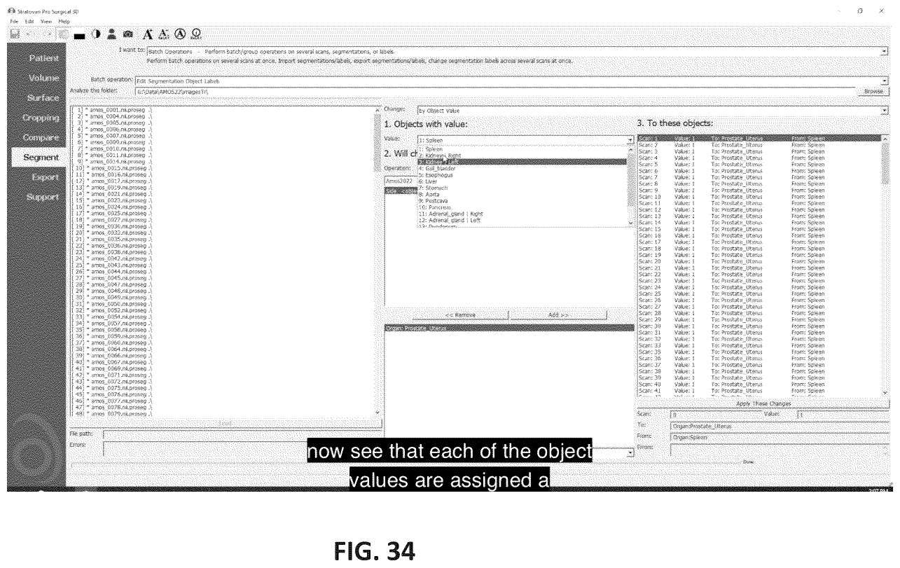

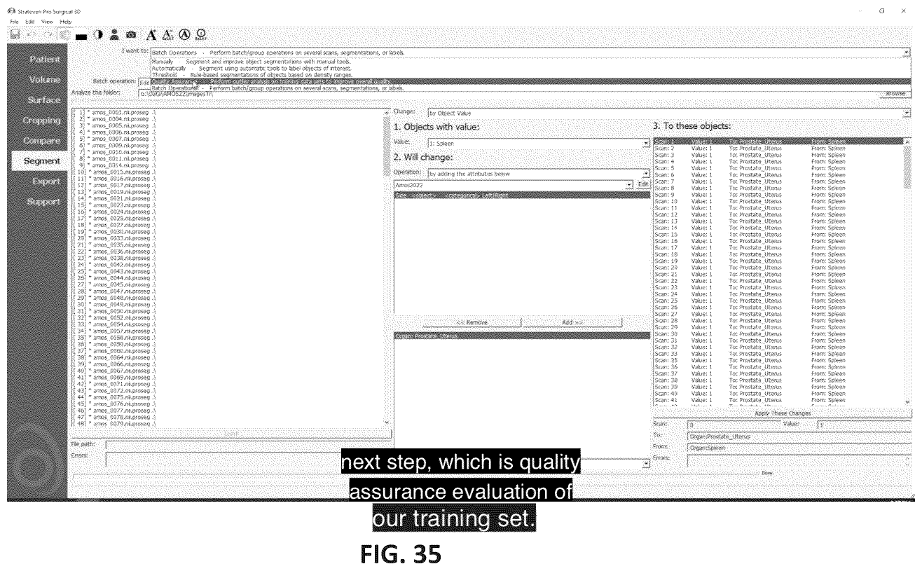

FIG. 33 depicts a step of executing defect analysis according to some embodiments. FIG. 34 shows a list of the attribute assignments according to some embodiments. FIG. 35 illustrates the execution of a defect analysis function, which may be referred to as “quality assurance” herein according to some embodiments.

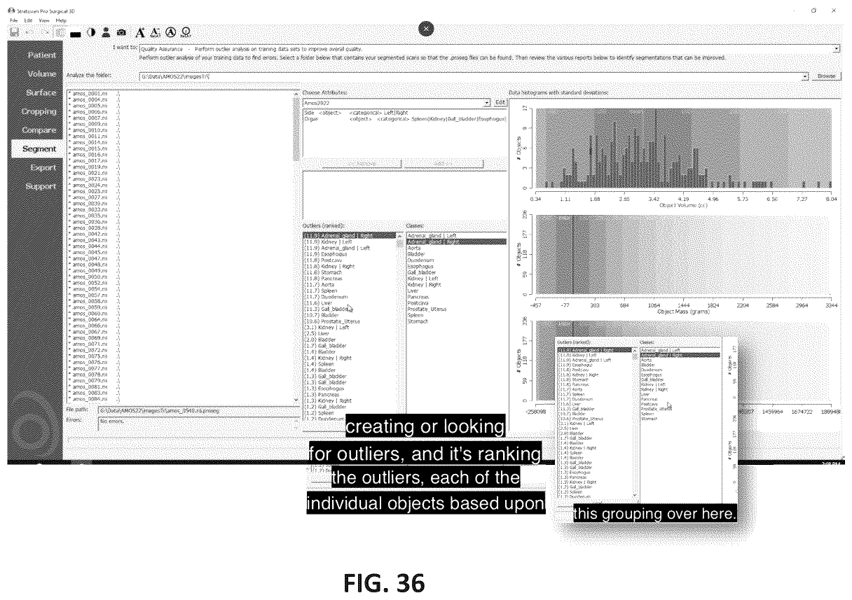

FIG. 36 shows the generation of a defect analysis GUI according to some embodiments. As mentioned above, the voxel data includes various attributes that define characteristics of a 3D image. In some embodiments, the voxel data includes edge data defining the boundary of a volume and/or voids within a continuous mass. In some embodiments, the system is configured to enable a user to enter a density for one or more segments and/or one or more volumes. In some embodiments, the system is configured to generate one or more statistical representations of the voxel data. In some embodiments, statistical representations include and object volume, object mass, and or some combination of the two. In some embodiments, the system is configured to enable a user to select one or more outliers from the statistical representation.

In some embodiments, by using voxel data to generate the statistical representation of image characteristics and enabling the selection and/or review of images for AI model learning based on characteristic outliers, the system integrates these features into a practical application that enables creation of datasets for better AI model training at an accelerated rate. In some embodiments, the identification and/or display of outliers enable identification of disease and/or unusual image characteristics that can be used to train further system AI models to automatically recognize those defects. In some embodiments, the system is configured to automatically execute Al analysis of a selected portion of or all images in an image set. In some embodiments, the system is configured to automatically use images within the image set that include one or more characteristics that fall within a predefined range of a statistical mean value as training data for an AI algorithm. Al models executed by the system are configured to identify one or more of shape, volume, size, and type of defect, as further described herein. In some embodiments the system is configured to assign one or more images that fall within a specified range (e.g., a mean value) as normal. In some embodiments, the specified range may include a specified deviation of a mean value, which may be a percent value, a standard deviation (e.g., 1, 2, 3, etc.) or some combination thereof. In some embodiments, the system is configured to return one or more defect classifications generated by the one or more AI modules.

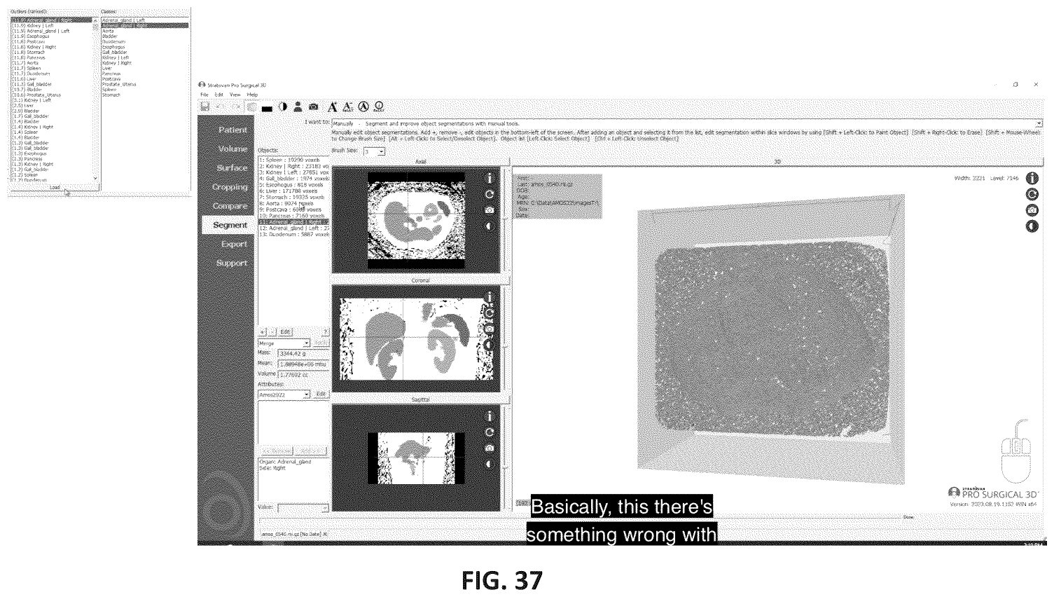

FIG. 37 shows an outlier image according to some embodiments. As shown in this non-limiting example, the shape and lack of volume in the image indicate a defective scan. This type of analysis is currently done manually and can only be identified visually after the file is open. However, current systems do not use voxel data to identify image characteristic outliers, so one would need to examine all images to find this single defective image: not finding it would cause problems in the machine learning process. In some embodiments, the system is configured to enable a user to isolate and/or remove an image from the group. In some embodiments, the system is configured to loads the scan and also select one or more outlier objects of interest, making the user's workflow streamlined and easy to follow.

In some embodiments, the system automatically removes the outlier. In some embodiments, the system is configured to enable a user to categorize the outlier, which may be used by a reviewer or an AI model as training data.

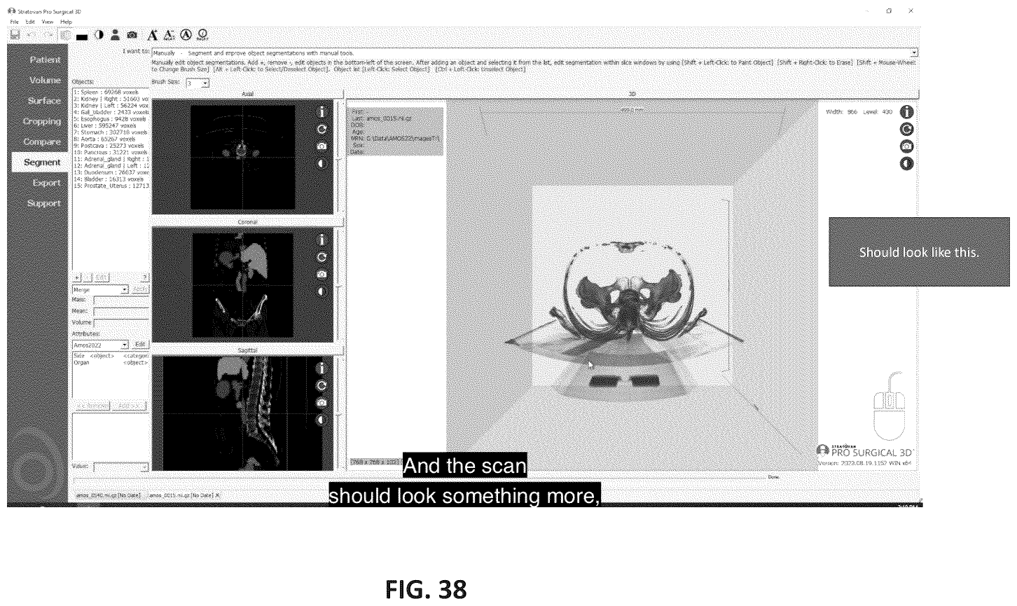

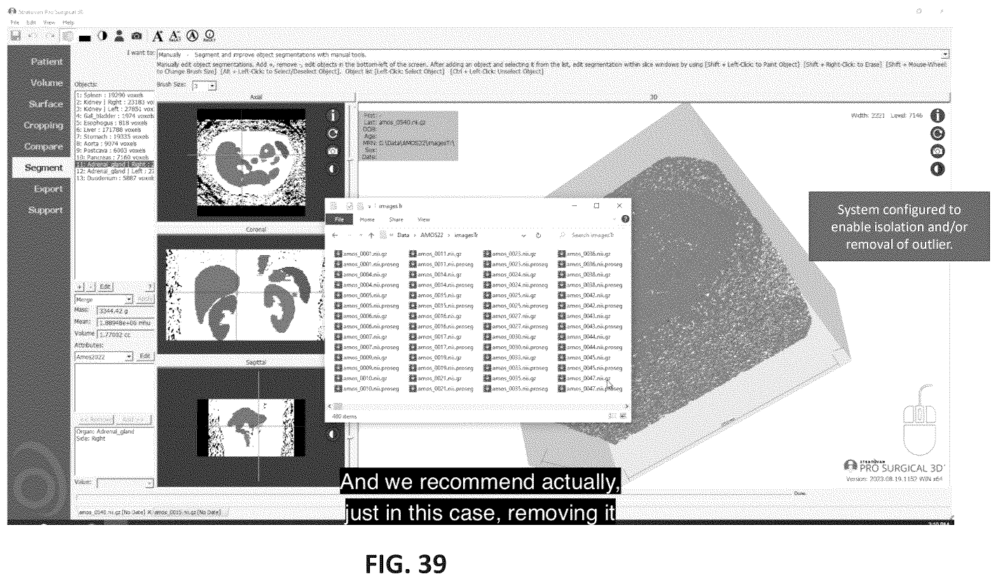

FIG. 38 depicts what an expected scan should look like according to some embodiments. Again, a benefit that some embodiments of the system provide is that identification of outlier characteristics in an image set can be identified without a user's visual review. This is especially useful to avoid errors by unexperienced evaluators and enables the creation of a review method according to some embodiments. In some embodiments, the review method includes one or more of the steps of identification of outliers in an image set by statistical comparison of image characteristics, removal and/or isolation of the outliers from the image set, assigning additional attributes to the outliers, sending the outliers to an AI model as a training set. FIG. 39 shows removing the outlier according to some embodiments.

In some embodiments, the system is configured to generate one or more training image groups by executing a grouping of one or more training images by assigned attribute. In some embodiments, the system is configured to compare each of the training images in the one or more groups to each other. In some embodiments, the system is configured to compare each of the one or more images to a training data. In some embodiments, the system is configured to compare training images within a training image group by one or more statistical characteristics. In some embodiments, statistical characteristics include one or more of shape, volume, and mass.

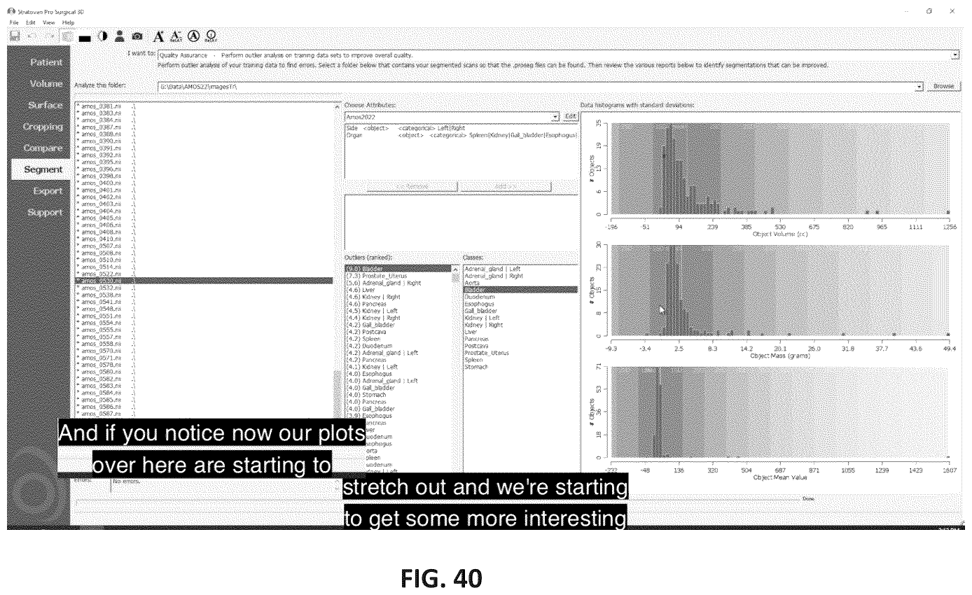

FIG. 40 illustrates the system executing a display of a change in the statistical representation according to some embodiments. In some embodiments, after each defect correction, the system is configured to iteratively search for an outlier (e.g., the largest outlier) in each representation category (e.g., mass, volume, mean value) and apply the defect analysis to the outlier. In some embodiments the system is configured to assign one or more images that fall within a specified range of a mean value as normal. In some embodiments, the specified range may include a specified deviation of a mean value, which may be a percent value, a standard deviation (e.g., 1, 2) or some combination thereof.

In some embodiments, the system is configured to display one or more outlier images that fall out of the specified range. In some embodiments, one or more outlier images include a list, an image, and/or statistical representation. In some embodiments, the system is configured to enable a user to select the one or more outliers from a list and/or the statistical representation (e.g., graph, histogram, bar chart, pie chart, etc.). In some embodiments, the list includes a ranking of one or more outlier images. In some embodiments, the list includes a ranking of each outlier image as compared to one or more other outlier images. In some embodiments, the ranking includes a value indicting an amount of data outside the specified range and/or a distance from a mean value.

In some embodiments, the system is configured to enable a user to select one or more outlier images from the list. In some embodiments, the system is configured to enable a user to exclude one or more outliers from the analysis. In some embodiments, the system is configured to group outlier by scan. As a non-limiting example, if a plurality of outlier images (e.g., bladder, spleen, and liver) are from a single scan (e.g., full body scan), the system is configured to generate a scan grouping, indicator, and or message showing that the scan is at least partially abnormal and/or unusual. In some embodiments, the system is configured to save one or more outlier images. In some embodiments, the system is configured to enable a user to assign one or more attribute values to each of the one or more outlier images. In some embodiments, the system is configured to use the one or more images as a training set for AI to automatically identify and/or classify similar outliers in future analysis. In some embodiments, one or more image comparisons described herein are executed using classified normal images and/or outlier images.

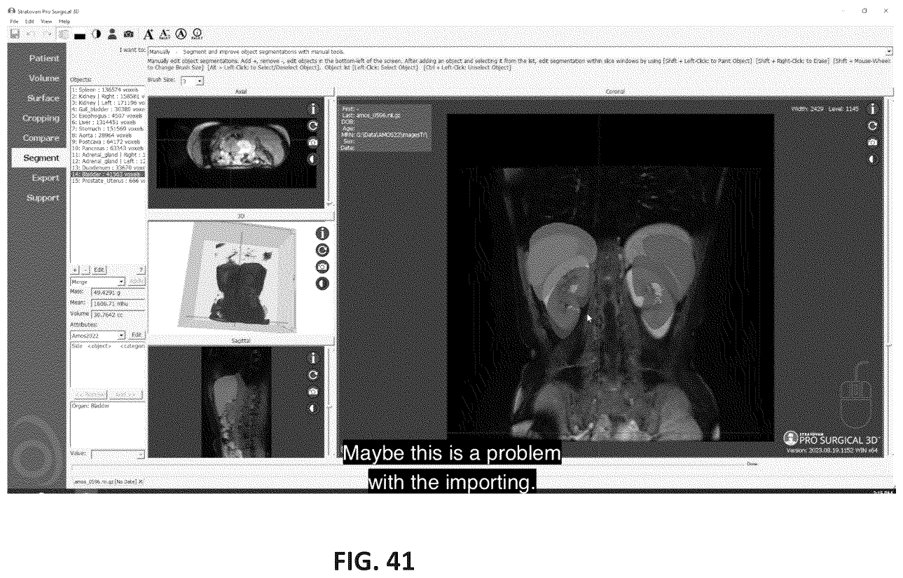

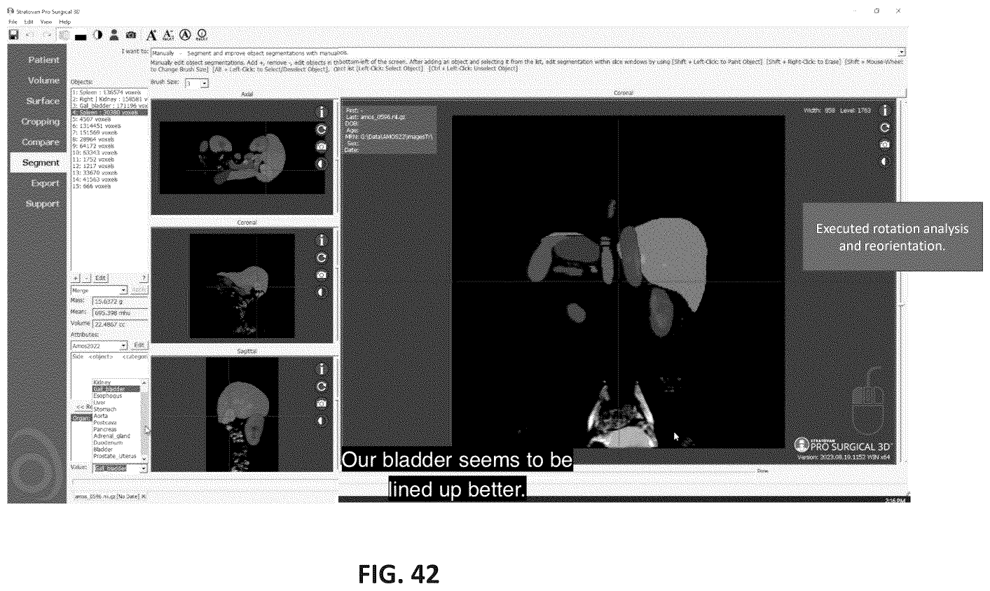

FIG. 41 shows an axis evaluation according to some embodiments. In some embodiments, the system is configured to automatically correct an image. In some embodiments, correcting an image includes rotating and/or reflecting a segmentation about one or more axes. In some embodiments, the system is configured to execute an axis evaluation using an Al model by comparing each rotation of the image to an Al axis training set. In some embodiments, the system is configured to apply the axis rotation that includes one or values closest to a mean of the sample set and or best fit to an Al training set. FIG. 42 illustrates a model fit through reflection according to some embodiments.

In some embodiments, the system is configured to save the modified data in the image file. In some embodiments, the system is configured to include the automatically corrected image in the next iteration of statistical evaluation of the image set. In some embodiments, if the image is still an outlier, another (AI) operation is executed by the system (e.g., artifact deletion) to attempt to correct defects. If the defective image continues to be an outlier after one or more (e.g., all) defect correction attempts, the system is configured to automatically remove and/or isolate the image and/or enable a user to delete and/or isolate the image. In some embodiments, the system is configured to display an indication that one or more images have been automatically corrected, isolated, and/or deleted. In some embodiments, the system is configured to indicate if one or more images have been reviewed.

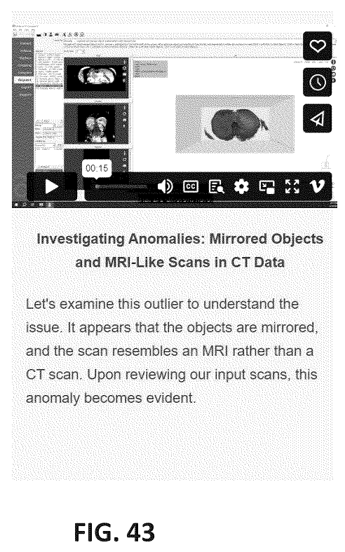

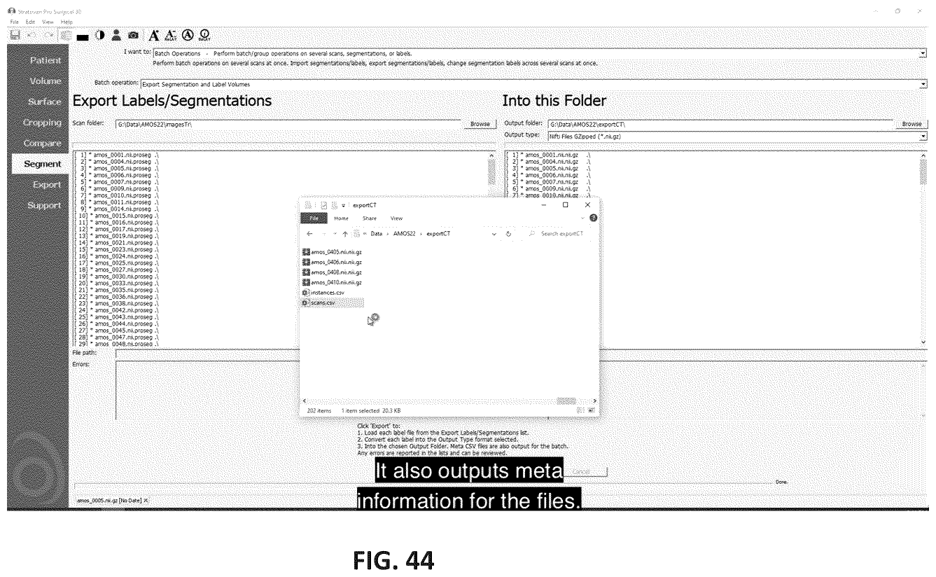

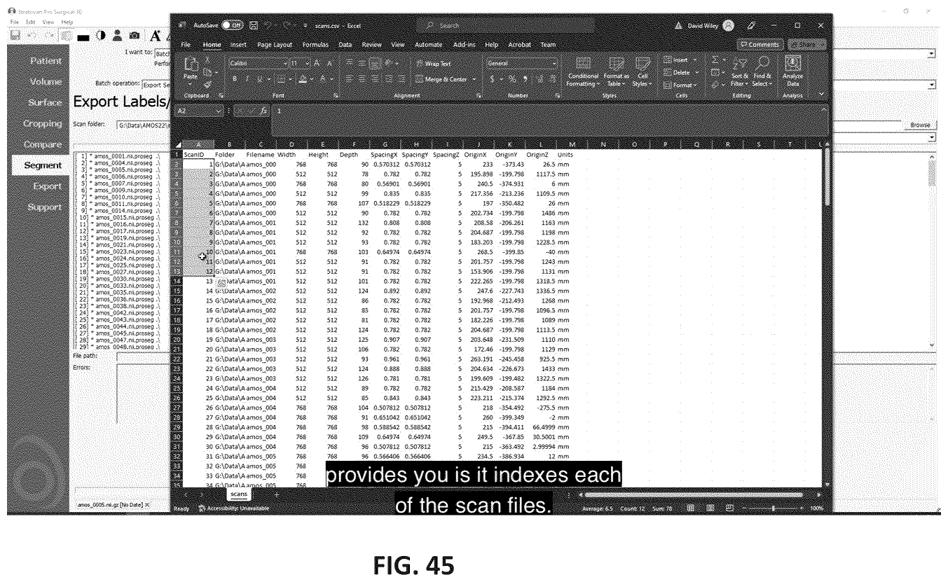

FIG. 43 illustrates one or more steps that include mirror and/or image type analysis according to some embodiments. FIG. 44 depicts the system generating data and/or metadata for one or more image files according to some embodiments. FIG. 45 shows a non-limiting example data indexing output according to some embodiments.

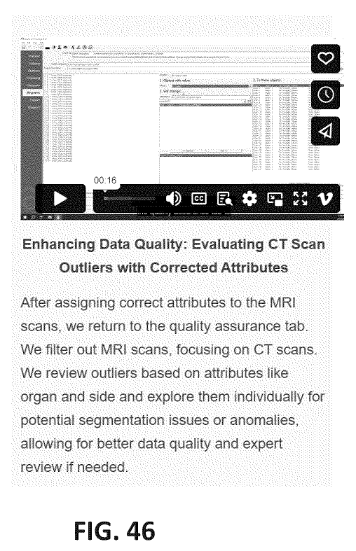

FIG. 46 shows one or more steps for executing image type evaluation according to some embodiments. In some embodiments, the system is configured to distinguish between image scan type. In some embodiments, image scan type includes MRI vs CT scan types. In some embodiments, the system is configured to classify one or more images by image scan type. In some embodiments, the system is configured to identify one or more first image scan types (e.g., MRI) among a plurality of second image scan types (e.g., CT). Different modalities among scan types can cause a negative impact on machine learning, so being able to identify and/or sort different scan types enables development of better training sets. In some embodiments, the system is configured to automatically sort images from a single storage location to multiple storage locations. In some embodiments, the same procedure is applied to the image labels for one or more image operations described herein.

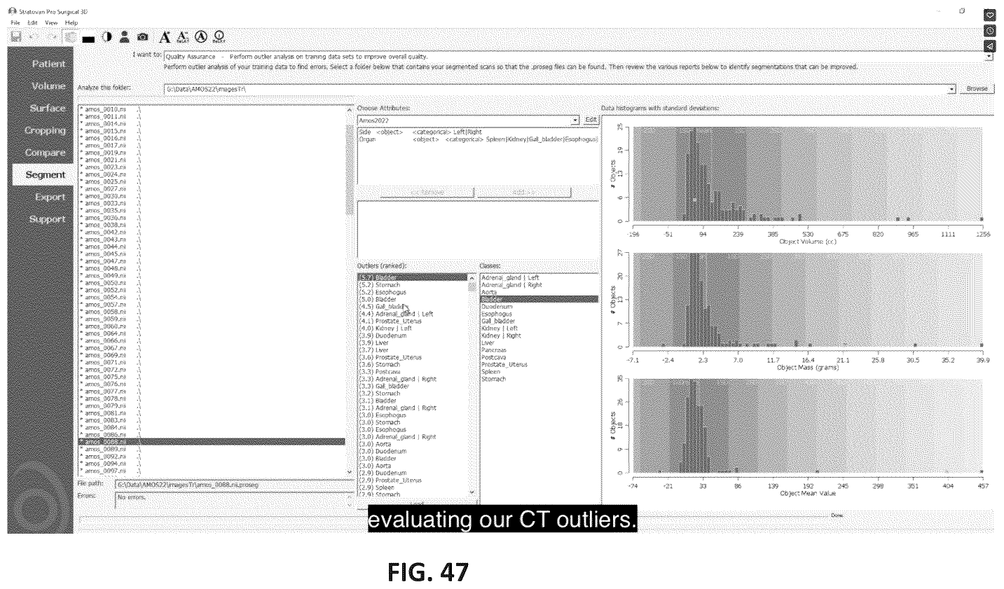

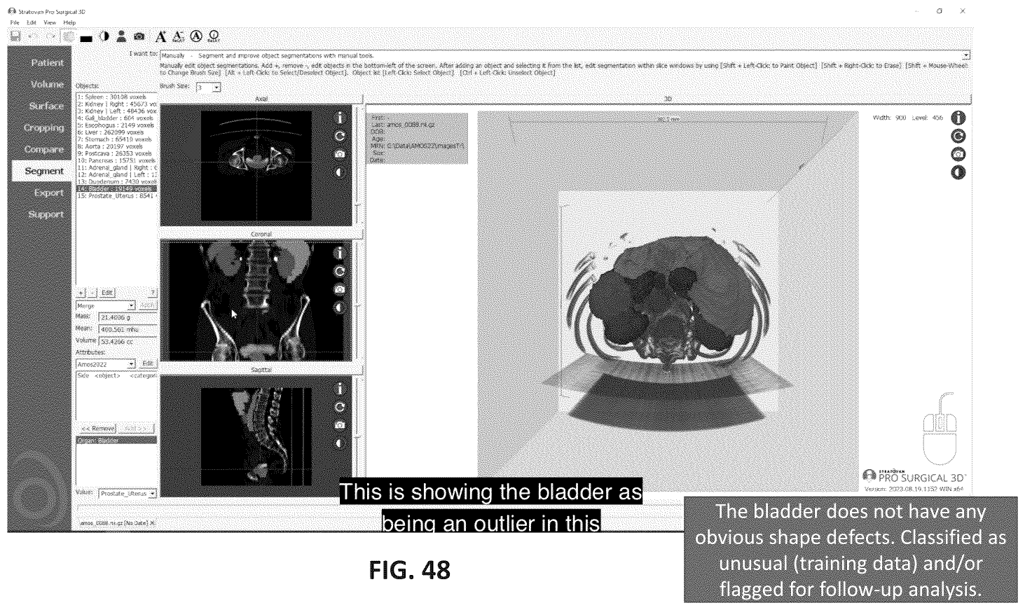

FIG. 47 illustrates evaluating CT scan outliers according to some embodiments. FIG. 48 depicts an unusual outlier according to some embodiments. In some embodiments, the unusual outlier comprises a normal volume (1 standard deviation (SD)) but an outlier mass (5 SD). In some embodiments, the system is configured to use a combination of a normal and/or outlier statistical representation of a characteristic to classify an object. This non-limiting example highlights the improvement in defect identification over a visual review according to some embodiments. As shown in FIG. 48 there does not appear to be any visual anomaly in the segmented image shape according to some embodiments. However, in some embodiments, the system is configured to classify an image as unusual if it doesn't fit any executed image comparison analysis and/or AI modeling. While this situation would normally go unnoticed by most, by using the systems and methods described herein the abnormal data can be reviewed before being included in the training set.

In some embodiments, the system includes an operator performance module. In some embodiments, the system is configured to track, store, and/or display operator performance for the evaluation process. In some embodiments, the system is configured to track operator events such as one or more of loading a file, saving a file, adding a segmentation object, labeling an object, deleting an object, changing a label of an object, reviewing an object, approving or disapproving an object segmentation, adding notes, etc. In some embodiments, these analyses allow a manager to review performance of their operators to, for example, find the best and worst performers. In some embodiments, the system is configured to enable evaluation of operator speed and quality and more.

Some embodiments enable forming operator groups such as “technician” or “reviewer” or “manager” to enable activities such as review or approvals within the workflow. For example, technicians create first level segmentations and labels according to some embodiments. Reviewers review those and approve, edit, or disapprove first-level segmentations by marking each object as such in some embodiments. In some embodiments, managers perform another review of all objects and mark objects as such. In some embodiments, this defines a workflow process and/or a flow for executing a display for image review. In some embodiments, creating these databases after this workflow ensures quality assurance reviews and procedures which ultimately produce robust, high-quality datasets that can be used to train machine learning algorithms.

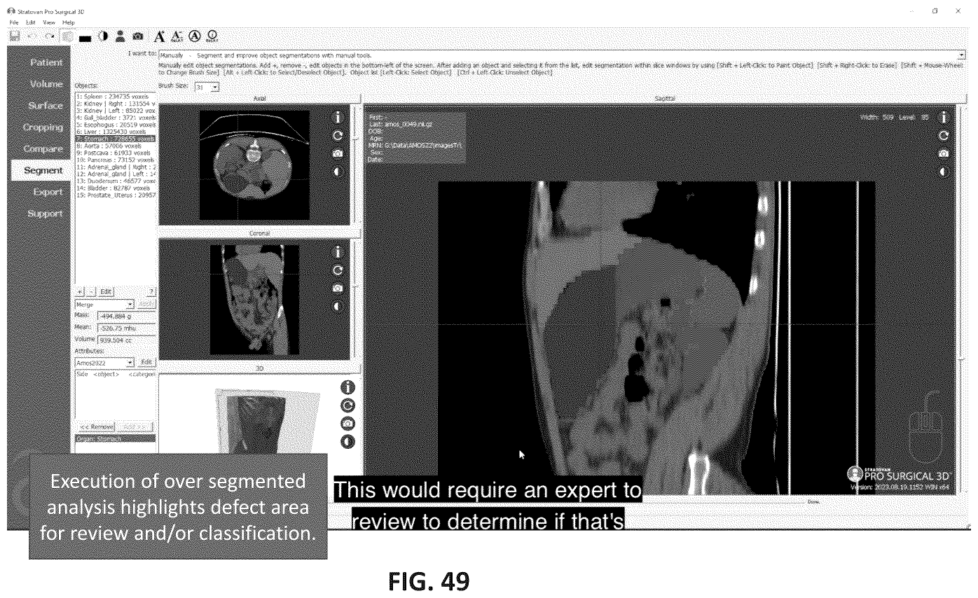

FIG. 49 shows a defect of interest in the unusual bladder mass according to some embodiments. In some embodiments, as described above, the system is configured to enable the operator to assign attributes to the identified abnormal image to train an AI model to recognize this anomaly, which may be a segmentation error in this non-limiting example. In some embodiments, the system includes a segmentation AI model configured to identify segmentation defects in one or more images.

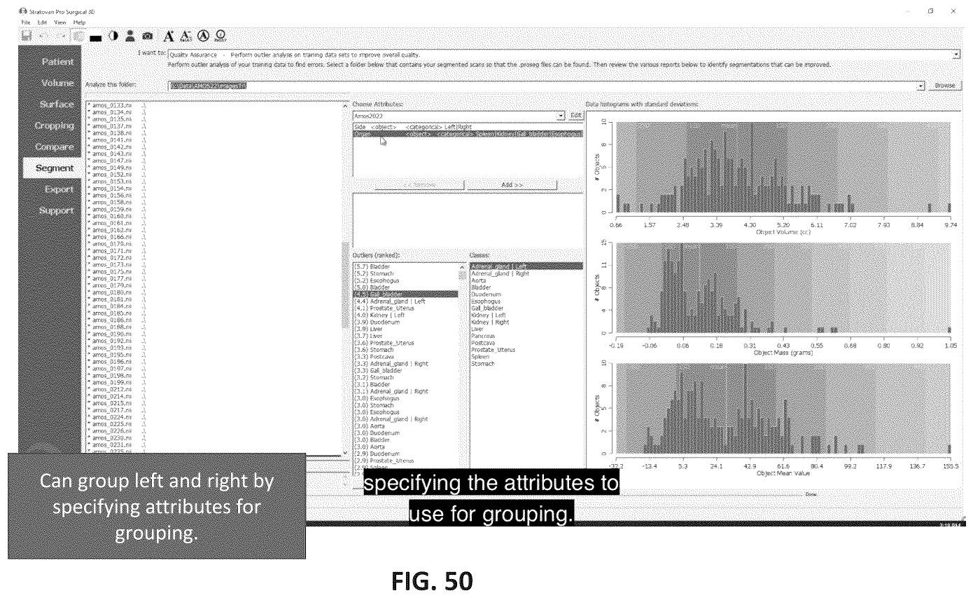

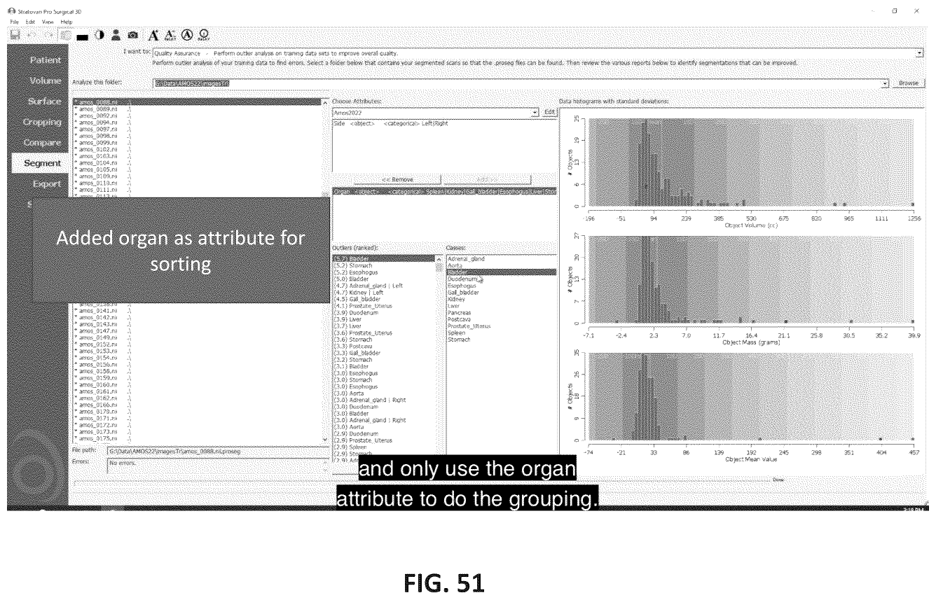

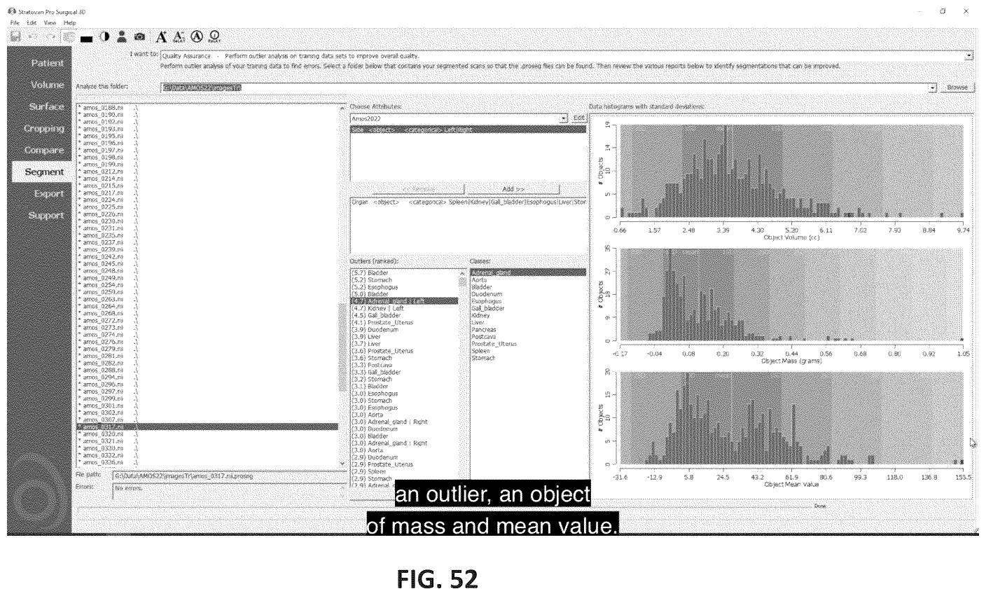

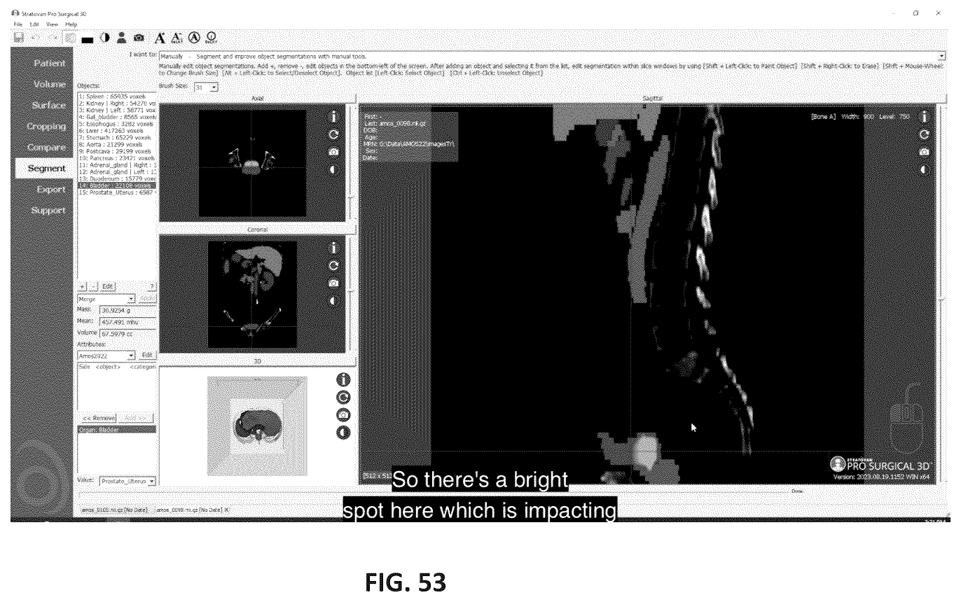

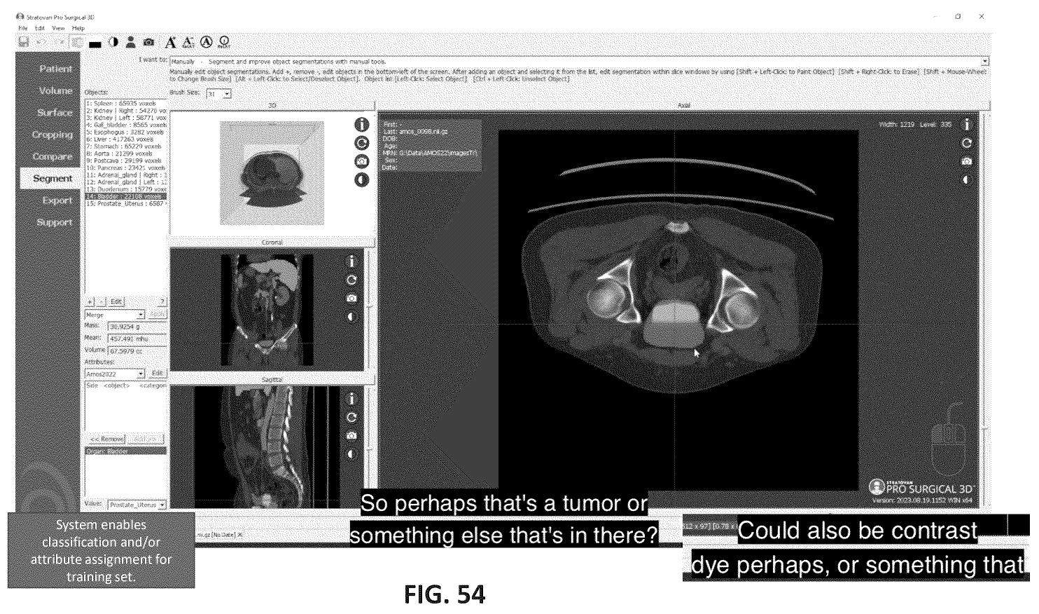

FIG. 50 depicts specifying attributes for grouping according to some embodiments. In some embodiments, the system is configured to enable a user to group one or more attributes together for statistical analysis and/or generation of the statistical representation. FIG. 51 shows adding an organ as an attribute for sorting according to some embodiments. FIG. 52 shows executing defect analysis on an attribute group according to some embodiments. FIG. 53 shows a display of a grouped outlier according to some embodiments. In some embodiments, the display shows a bright spot, which is causing an increase in mass. FIG. 54 shows classification and attribute assignment for the image according to some embodiments.

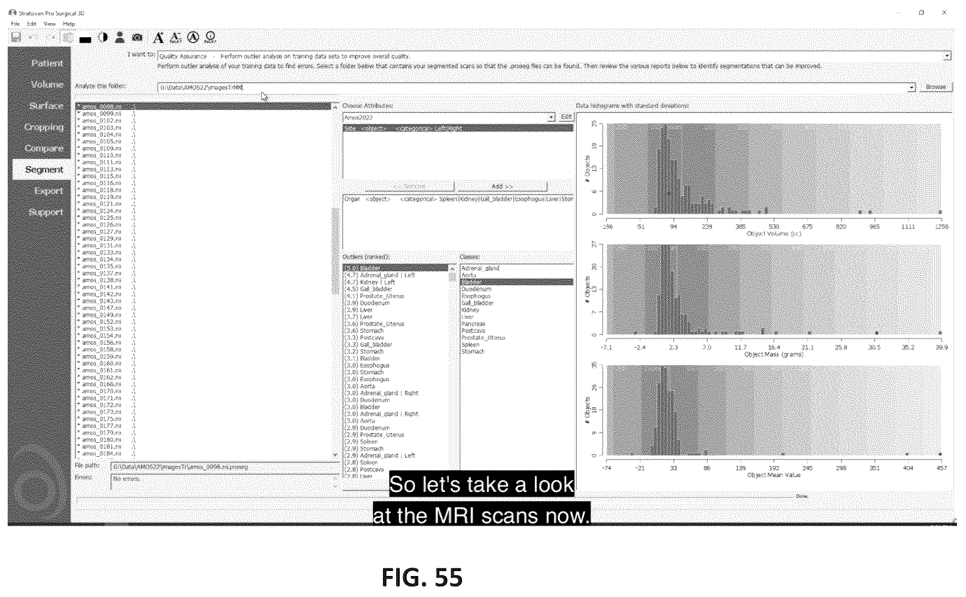

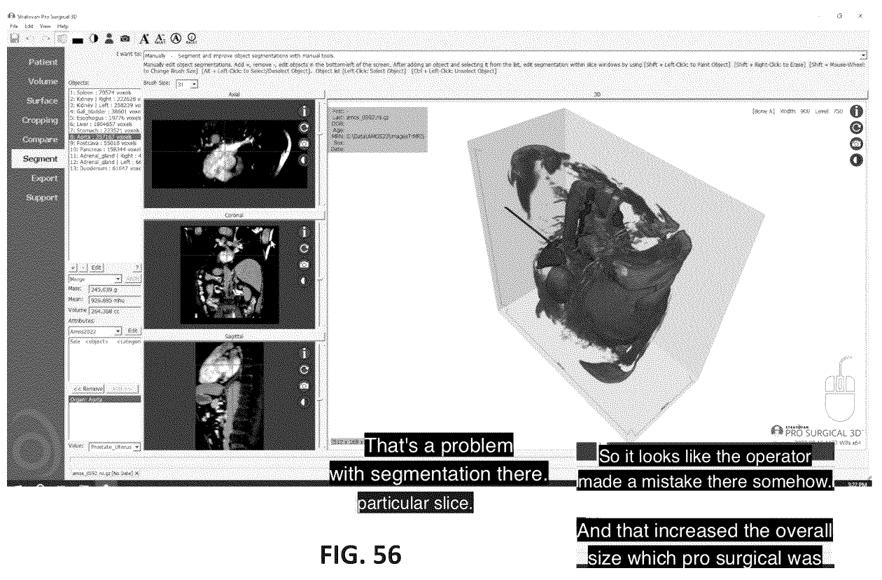

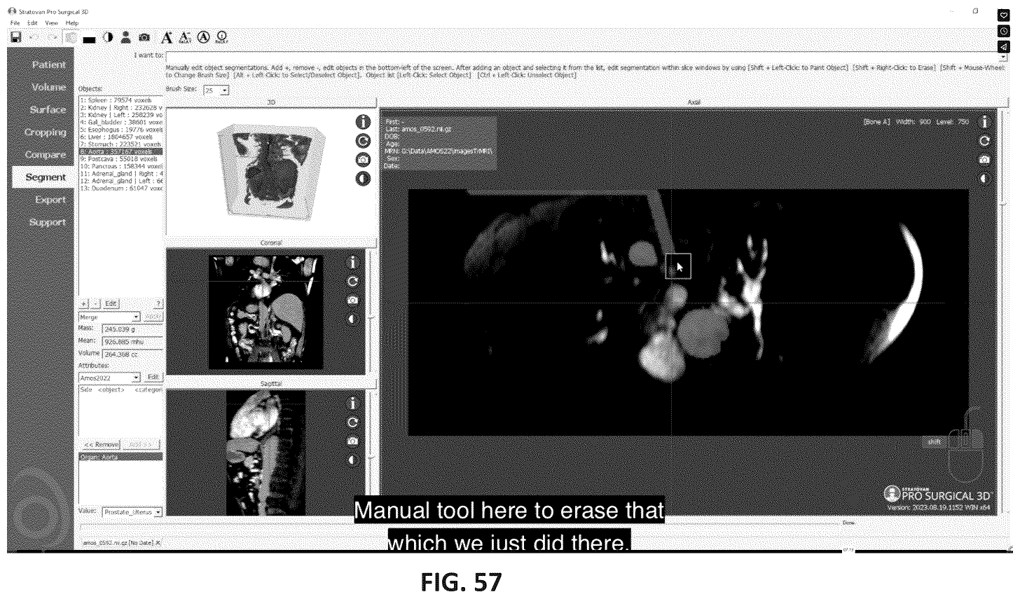

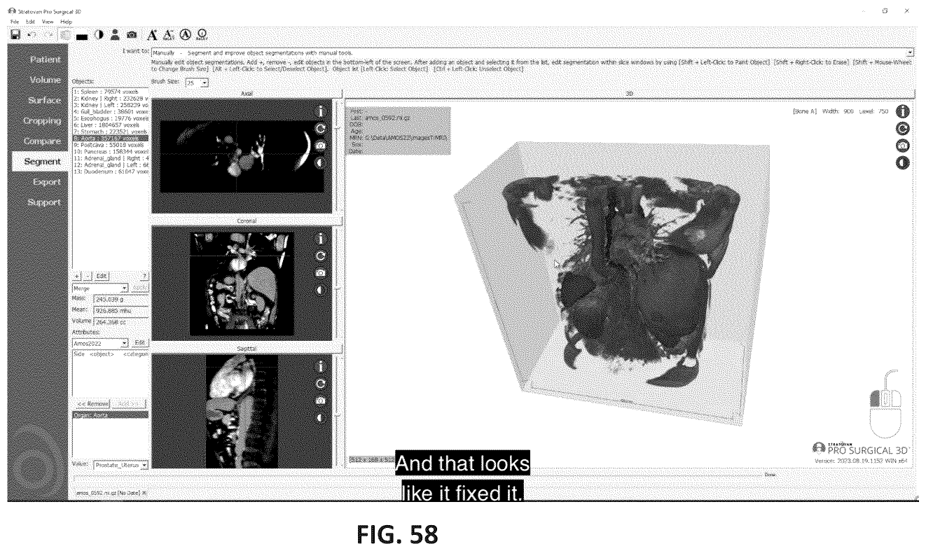

FIG. 55 shows an MRI scan type analysis according to some embodiments. In some embodiments, the system is configured to automatically classify by scan type, which enables proper training of AI models as the different modalities can have negative effects on model training. FIG. 56 shows an unusual image with an artifact. FIG. 57 depicts the execution of a manual defect tool removing the artifact according to some embodiments. FIG. 58 show the fixed image returned to the data set according to some embodiments.

In some embodiments, the system comprises an artifacts AI model. In some embodiments, the artifacts AI model is configured to identify one or more voxels as an artifact. In some embodiments, the system is configured to automatically delete one or more identified artifact voxels.

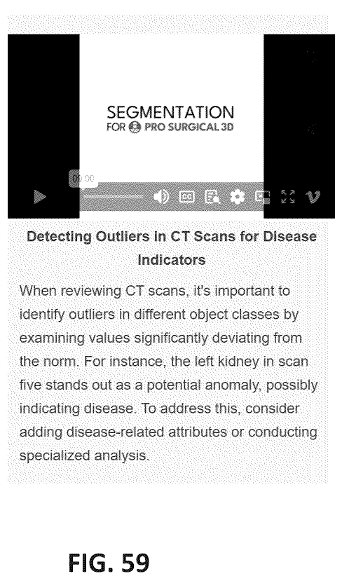

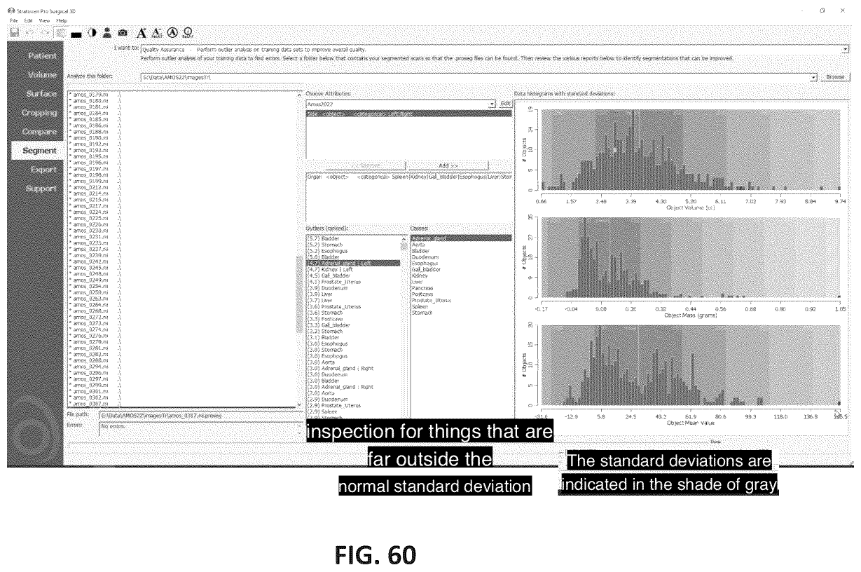

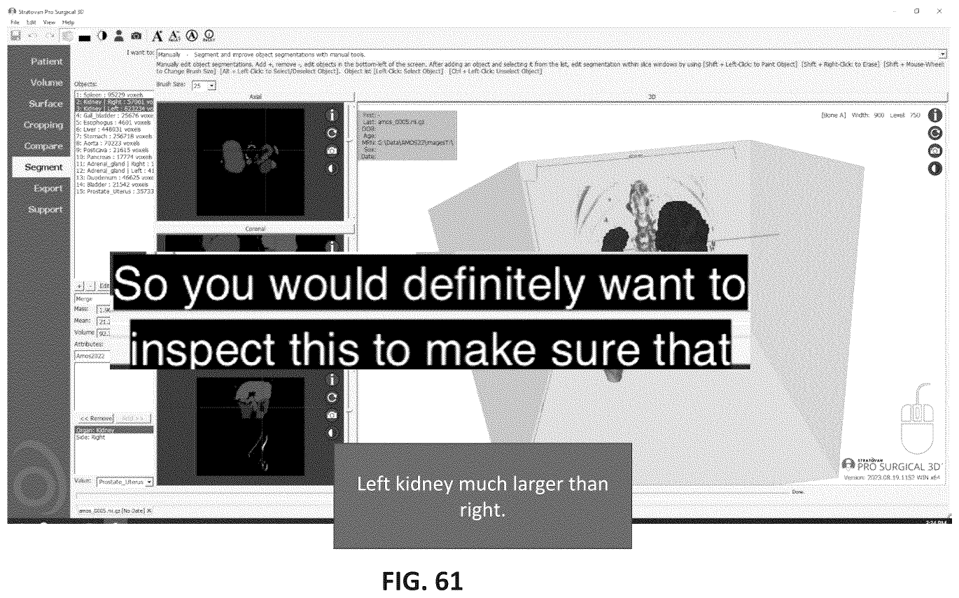

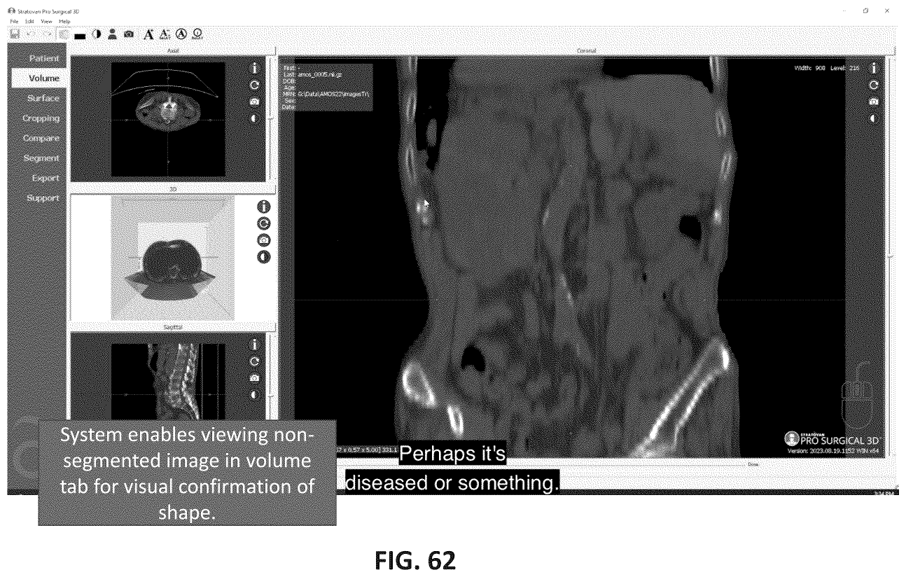

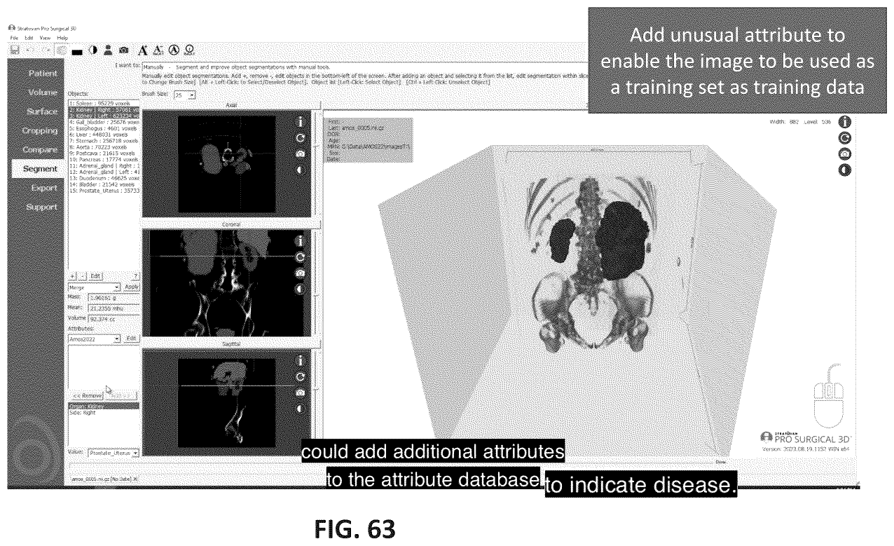

FIG. 59 depicts steps for executing a medical evaluation according to some embodiments. In some embodiments, a medical evaluation includes disease evaluation. FIG. 60 shows selection of an outlier in a combined statistical representation category according to some embodiments. The object mean value is far outside of what is expected according to some embodiments. FIG. 61 shows a review of the outlier revealing a left kidney that is much larger than the right. FIG. 62 illustrates generating a volume image without segmentation according to some embodiments. In some embodiments, the system includes a medical evaluation AI model. FIG. 63 depicts adding attributes to the image to use as training data for the medical evaluation AI model.

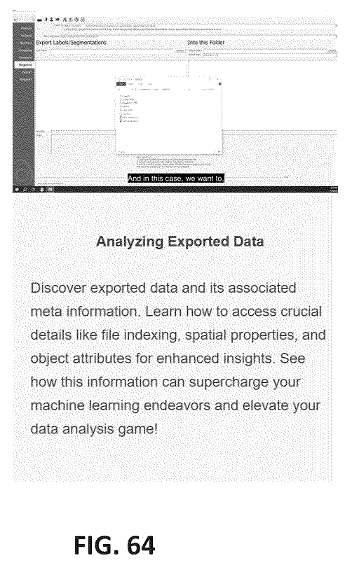

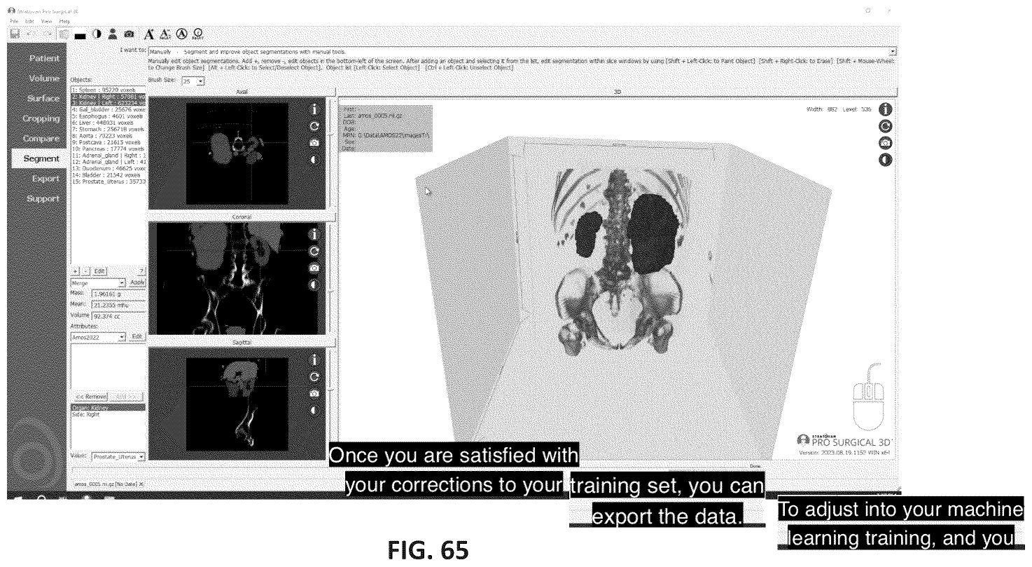

FIG. 64 shows a step of analyzing exported data according to some embodiments. FIG. 65 shows a labeled unusual outlier according to some embodiments. In some embodiments, once all corrections have been applied by one or more of manual and/or automatic actions, the system is configured to send the verified images to an AI model as a training set.

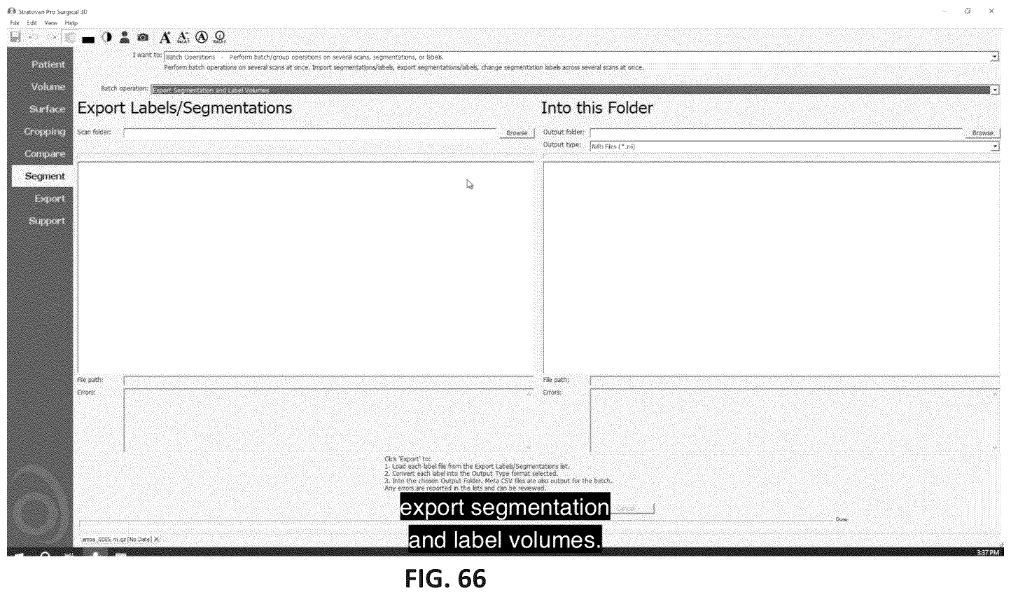

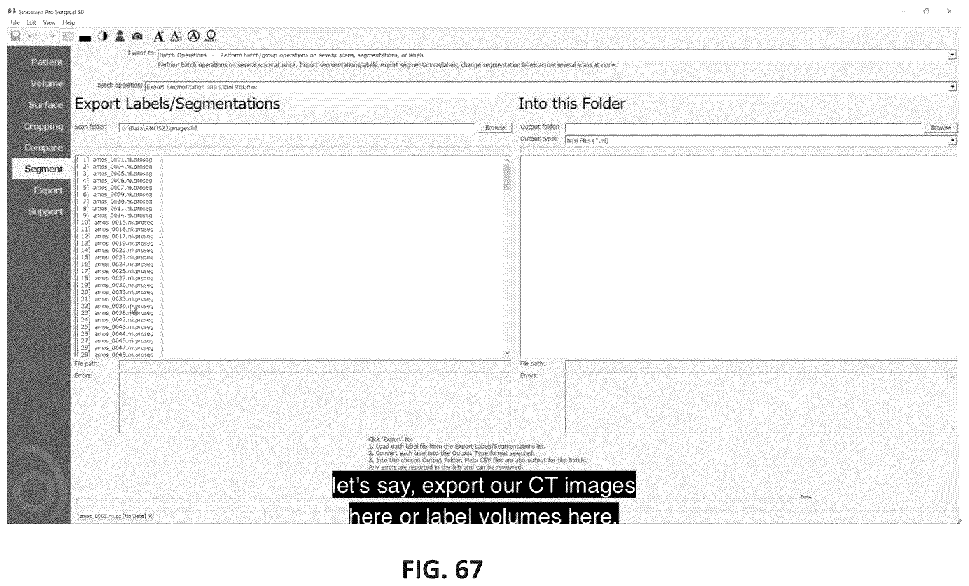

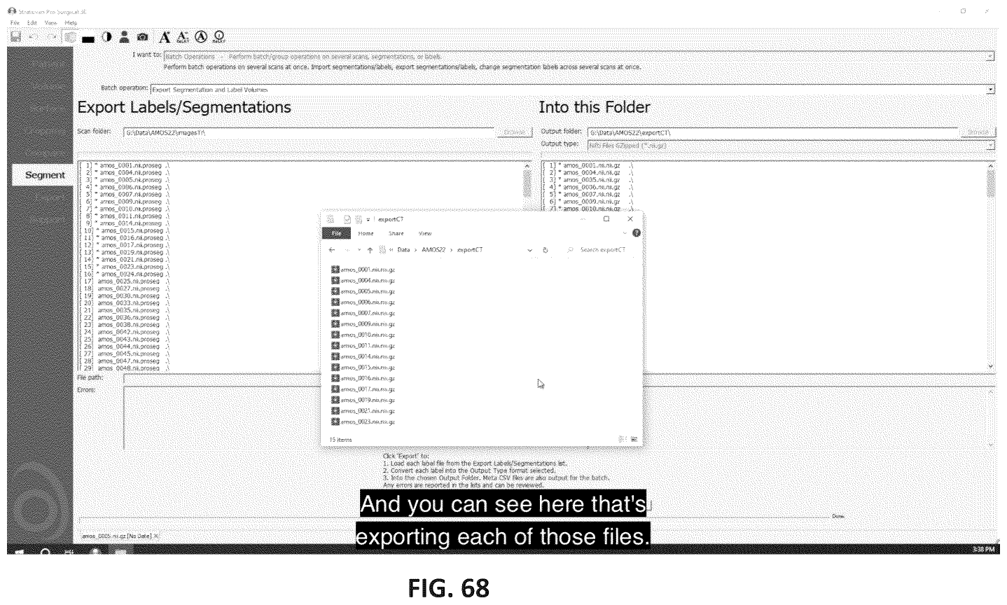

FIG. 66 shows an exporting function of the segment module according to some embodiments. FIG. 67 shows the population of the export section with CT images. FIG. 68 shows exporting of images and labels according to some embodiments.

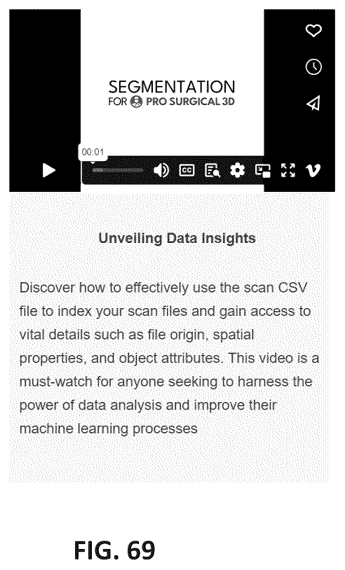

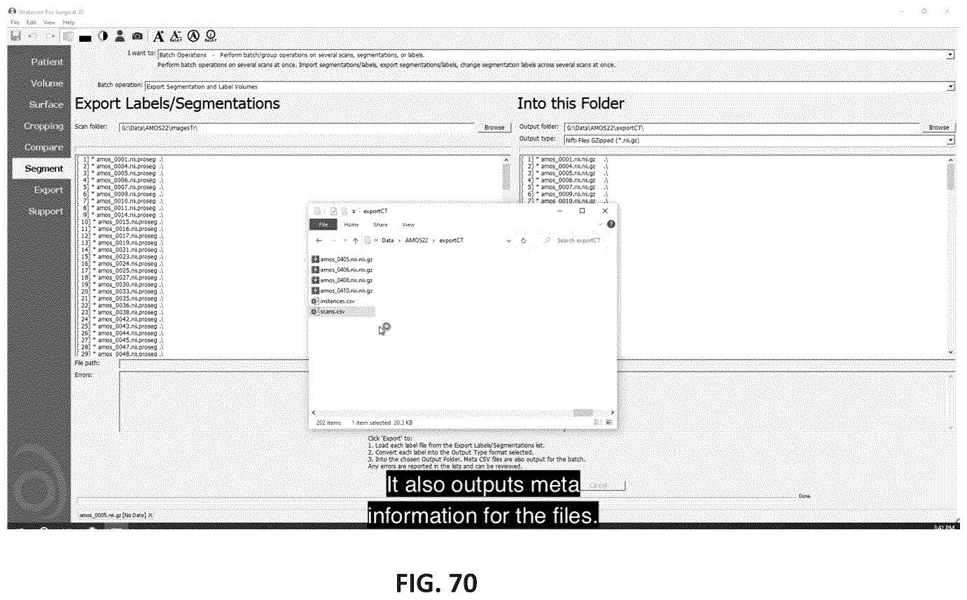

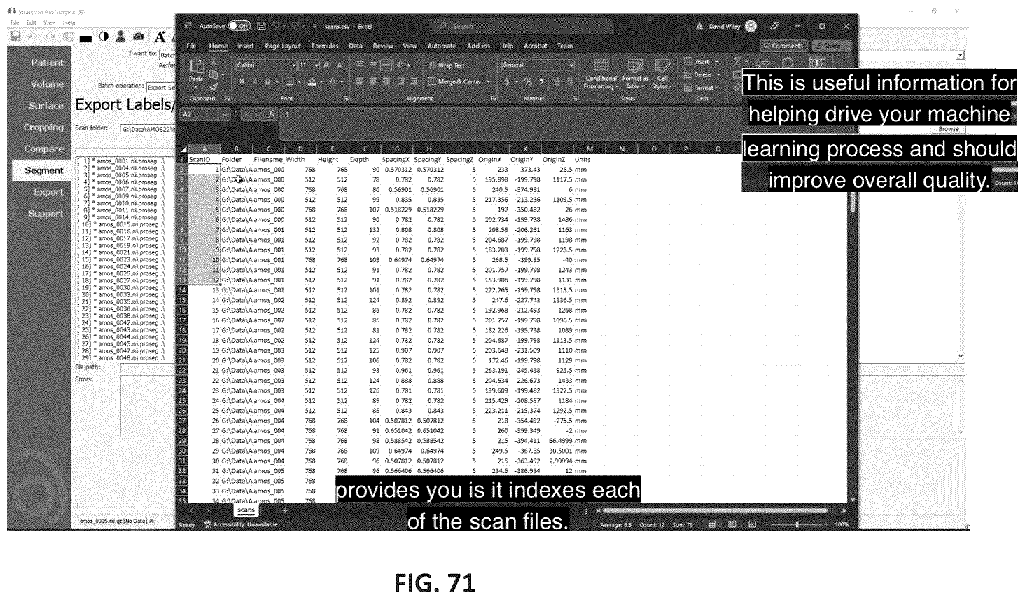

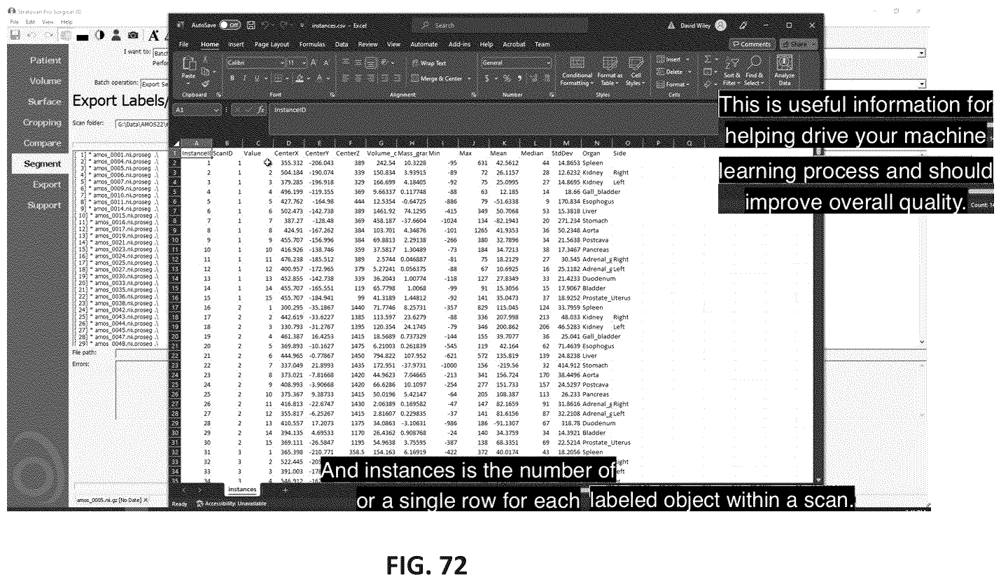

FIG. 69 shows steps for using an output file for further analysis according to some embodiments. FIG. 70 shows the system generating and/or outputting metadata associated with the reviewed images according to some embodiments. FIG. 71 displays an indexing scan output data according to some embodiments. FIG. 72 shows an instance output dataset according to some embodiments. In some embodiments, this data can be used to increase the quality of a machine learning process.

In some embodiments, the system includes one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. In some embodiments, the system is configured to implement an XGBoost algorithm for regression and/or classification to analyze the sensor data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of a neural network may be executed as follows:
a. define neural network architecture/model for the control framework,
b. transfer the input data to the neural network model,
c. train the model incrementally,
d. determine the accuracy for a specific number of timesteps,
c. apply the trained model to process the newly received input data,
f. optionally and in parallel, continue to train the trained model with a predetermined periodicity.

In some embodiments and, optionally, in combination of any embodiment described above or below, the trained AI model may specify a neural network by at least a neural network topology, a series of activation functions, and connection weights. For example, in some embodiments, the topology of a neural network may include a configuration of nodes of the neural network and connections between such nodes. In some embodiments, in combination of any embodiment described above or below, the trained AI model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments, the aggregation function may be a mathematical function that combines (e.g., sum, product, and the like) input signals to the node. In some embodiments, an output of the aggregation function may be used as input to the activation function. In some embodiments, the bias may be a constant value or function that may be used by the aggregation function and/or the activation function to make the node more or less likely to be activated.

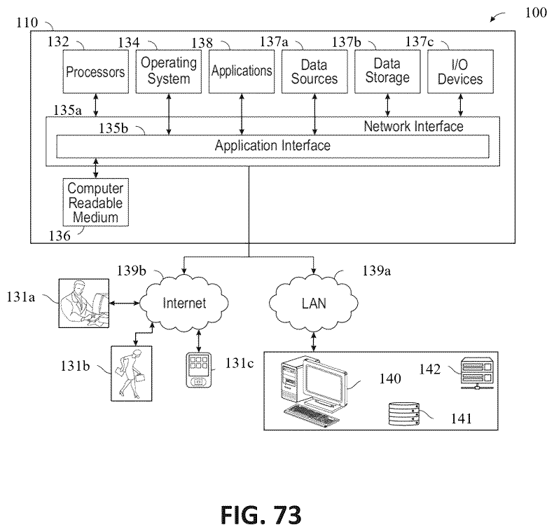

FIG. 73 illustrates a computer system 100 enabling or comprising the systems and methods in accordance with some embodiments. In some embodiments, the computer system 110 is configured to operate and/or process computer-executable code of one or more software modules of the aforementioned system and method. Further, in some embodiments, the computer system 110 is configured to operate and/or display information within one or more graphical user interfaces (e.g., HMIs) integrated with or coupled to the system.

In some embodiments, the computer system 110 comprises one or more processors 132. In some embodiments, at least one processor 132 resides in, or is coupled to, one or more servers. In some embodiments, the computer system 110 includes a network interface 135a and an application interface 135b coupled to the least one processor 132 capable of processing at least one operating system 134. Further, in some embodiments, the interfaces 135a, 135b coupled to at least one processor 132 are configured to process one or more of the software modules (e.g., such as enterprise applications 138). In some embodiments, the software application modules 138 includes server-based software. In some embodiments, the software application modules 138 are configured to host at least one user account and/or at least one client account, and/or are configured to operate to transfer data between one or more of these accounts using one or more processors 132.

With the above embodiments in mind, it is understood that the system is configured to execute various computer-implemented program steps involving data stored on one or more non-transitory computer media according to some embodiments. In some embodiments, the above-described databases and models described throughout this disclosure are configured to store analytical models and other data on non-transitory computer-readable storage media within the computer system 110 and on computer-readable storage media coupled to the computer system 110 according to some embodiments. In addition, in some embodiments, the above-described applications of the system are stored on computer-readable storage media within the computer system 110 and on computer-readable storage media coupled to the computer system 110. In some embodiments, these operations are those requiring physical manipulation of structures including electrons, electrical charges, transistors, amplifiers, receivers, transmitters, and/or any conventional computer hardware in order to transform an electrical input into a different output. In some embodiments, these structures include one or more of electrical, electromagnetic, magnetic, optical, and/or magneto-optical signals capable of being stored, transferred, combined, compared and otherwise manipulated. In some embodiments, the computer system 110 comprises at least one computer readable medium 136 coupled to at least one of at least one data source 137a, at least one data storage 137b, and/or at least one input/output 137c. In some embodiments, the computer system 110 is embodied as computer readable code on a computer readable medium 136. In some embodiments, the computer readable medium 136 includes any data storage that stores data, which is configured to thereafter be read by a computer (such as computer 140). In some embodiments, the non-transitory computer readable medium 136 includes any physical or material medium that is used to tangibly store the desired information, steps, and/or instructions and which is configured to be accessed by a computer 140 or processor 132. In some embodiments, the non-transitory computer readable medium 136 includes hard drives, network attached storage (NAS), read-only memory, random-access memory, FLASH-based memory, CD-ROMs, CD-Rs, CD-RWs, DVDs, magnetic tapes, and/or other optical and non-optical data storage. In some embodiments, various other forms of computer-readable media 136 are configured to transmit or carry instructions to one or more remote computers 140 and/or at least one user 131, including a router, private or public network, or other transmission or channel, both wired and wireless. In some embodiments, the software application modules 138 are configured to send and receive data from a database (e.g., from a computer readable medium 136 including data sources 137a and data storage 137b that comprises a database), and data is configured to be received by the software application modules 138 from at least one other source. In some embodiments, at least one of the software application modules 138 are configured to be implemented by the computer system 110 to output data to at least one user 131 via at least one graphical user interface rendered on at least one digital display.

In some embodiments, the one or more non-transitory computer readable 136 media are distributed over a conventional computer network via the network interface 135a where some embodiments stored the non-transitory computer readable media are stored and executed in a distributed fashion. For example, in some embodiments, one or more components of the computer system 110 are configured to send and/or receive data through a local area network (“LAN”) 139a and/or an internet coupled network 139b (e.g., such as a wireless internet). In some embodiments, the networks 139a, 139b include one or more wide area networks (“WAN”), direct connections (e.g., through a universal serial bus port), or other forms of computer-readable media 136, and/or any combination thereof.

In some embodiments, components of the networks 139a, 139b include any number of personal computers 140 which include for example desktop computers, laptop computers, and/or any fixed, generally non-mobile internet appliances coupled through the LAN 139a. For example, some embodiments include one or more personal computers 140, databases 141, and/or servers 142 coupled through the LAN 139a that are configured for use by any type of user including an administrator. Some embodiments include one or more personal computers 140 coupled through network 139b. In some embodiments, one or more components of the computer system 110 are configured to send or receive data through an internet network (e.g., such as network 139b). For example, some embodiments include at least one user 131a, 131b, coupled wirelessly and accessing one or more software modules of the system including at least one enterprise application 138 via an input and output (“I/O”) 137c. In some embodiments, the computer system 110 is configured to enable at least one user 131a, 131b, to be coupled to access enterprise applications 138 via an I/O 137c through LAN 139a. In some embodiments, the user 131 includes a user 131a coupled to the computer system 110 using a desktop computer, and/or laptop computers, or any fixed, generally non-mobile internet appliances coupled through the internet 139b. In some embodiments, the user includes a mobile user 131b coupled to the computer system 110. In some embodiments, the user 131b connects using any mobile computing 131c to wireless coupled to the computer system 110, including, but not limited to, one or more personal digital assistants, at least one cellular phone, at least one mobile phone, at least one smart phone, at least one pager, at least one digital tablet, and/or at least one fixed or mobile internet appliances.

The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements and advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean clement A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function according to some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the system are useful machine operations. The system also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the system can also be defined as a machine that transforms data from one state to another state. The data can represent an article, which can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the system has been described above in connection with particular embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

1. A system comprising:
one or more computers comprising one or more processors and one or more non-transitory computer readable media, the one or more non-transitory computer readable media comprising program instructions stored thereon that when executed cause the one or more computers to:
import, by the one or more processors, an image set, where each image in the image set comprises 3D image data comprising voxel data, wherein the voxel data includes a voxel value representing properties of an object in 3D space;
execute, by the one or more processors, a defect analysis configured to identify outliers in the 3D image data by comparing a statistical representation of the voxel data to a predefined threshold;
generate, by the one or more processors, a graphical user interface (GUI) configured to display the identified outliers in the image set; and
enable a user to select one or more images in the image set based on the identified outliers from the statistical representation.

2. The system of claim 1,
wherein the system is configured to automatically use images within the image set that include one or more characteristics that fall within a specified range of a statistical value as training data for an artificial intelligence (AI) algorithm.

3. The system of claim 1,
wherein the voxel data includes values representing tissue density.

4. The system of claim 1,
where the 3D image data comprises segmented 3D image data.

5. The system of claim 4,
where the one or more non-transitory computer readable media include further program instructions stored thereon that when executed cause the one or more computers to:
enable, by the one or more processors, the user to assign attributes to the identified outliers for training of a defect identification artificial intelligence (AI) model.

6. The system of claim 5,
where the one or more non-transitory computer readable media include further program instructions stored thereon that when executed cause the one or more computers to:
execute, by the one or more processors, the defect identification AI model to classify defects in segmented 3D images based on the assigned attributes.

7. The system of claim 6,
wherein the system is configured to assign one or more images that fall within a specified range as normal.

8. The system of claim 7,
wherein the specified range includes one or more of a specified deviation of a mean value, a percent value, and a standard deviation.

9. The system of claim 1,
wherein the system is configured to automatically remove the identified outliers.

10. The system of claim 1,
wherein the system is configured to enable the user to categorize the identified outliers.

11. The system of claim 1,
where the system is configured to automatically correct an image.

12. The system of claim 11,
wherein correcting an image includes rotating and/or reflecting the image about one or more axes.

13. The system of claim 11,
the system is configured to execute an axis evaluation using an axis artificial intelligence (AI) model.

14. The system of claim 13,
wherein the axis AI model is configured to execute the axis evaluation by comparing a plurality of rotations of the image to an axis training set.

15. The system of claim 13,
wherein the system is configured to apply an axis rotation that includes one or values closest to a mean of an axis training set.

16. The system of claim 15,
wherein the system is configured to apply the axis rotation that includes one or values closest to a best fit to an axis training set.

17. The system of claim 1,
wherein the system is configured to automatically correct a defective image.

18. The system of claim 17,
wherein the system is configured to execute an iteration of the defect analysis after the defective image is corrected.

19. The system of claim 18,
wherein the system is configured to remove the defective image and/or isolate the defective image if the defective image continues to be an outlier after the iteration.

20. The system of claim 17,
wherein the system is configured to display an indication that one or more images have been automatically corrected.
